(19) United States
(12) Patent Application Publication
(10) Pub. No.: US 2018/0283025 A1
(43) Pub. Date: Oct. 4, 2018

(54) ONE-PIECE SHINGLE REPAIR PATCH

(71) Applicant: Thomas R. Mathieson, Louisville, CO (US)

(72) Inventor: Thomas R. Mathieson, Louisville, CO (US)

(21) Appl. No.: 16/002,501

(22) Filed: Jun. 7, 2018

Related U.S. Application Data
(63) Continuation-in-part of application No. 15/486,665, filed on Apr. 13, 2017.
Application No. 15/486,665 is a continuation-in-part of application No. 14/965,559, filed on Dec. 10, 2015, now Pat. No. 9,631,383.

(51) Int. Cl. E04G 23/02; E04D 1/20; B32B 7/12; B32B 3/06

(52) U.S. Cl. CPC E04G 23/0281; E04D 1/20; E04D 2001/005; B32B 3/06; B32B 7/12

(57) ABSTRACT

A shingle patch for repairing damaged shingles or overlaying exposed nails on a roof structure including a base member with and without a notched portion on one end for sliding under an existing shingle located above the damaged shingle or the shingle with exposed nails, a sealant covering at least a portion of the notched portion and the bottom surface of the base member for attaching the base member to the damaged shingle or to another shingle, and color granules associated with at least a portion of the top surface of the base member. The shingle patch can likewise include a fold for mating with a peak on a roof for overlaying exposed nails associated with a last ridge cap shingle or it can be used flat to cover exposed nails at roof/wall intersections and the like. The notched portion can also be formed solely from the sealant member.

### CROSS-REFERENCE TO RELATED APPLICATION

This application claims priority to U.S. patent application Ser. No. 15/486,665, filed Apr. 13, 2017, which claims priority to and the benefit of U.S. Pat. No. 9,631,383, issued Apr. 25, 2017. The entire disclosures of U.S. application Ser. No. 15/486,665 and U.S. Pat. No. 9,631,383 are hereby incorporated herein by reference.

### BACKGROUND OF THE INVENTION

The present invention relates generally to systems and methods for repairing and sealing asphalt shingles and, more particularly, to several embodiments of a shingle patch for repairing damaged asphalt shingle and for overlaying exposed nails on a roof structure.

Shingled roofs are typically laid in an overlapping pattern which necessarily requires the roofer to begin laying the shingles at the lowest point of the roof and moving horizontally until one row of shingles is complete. Asphalt shingles are typically nailed to the roof along the uppermost perimeter edge and the horizontal rows progress upwardly with each asphalt shingle slightly overlapping the one below it, thereby covering the nails securing the underlying shingle. With this progression, the shingles are laid in an overlapping specific pattern and it can be seen that at certain positions on the roof, for example, at edges abutting dormers, chimneys, and at the last row of shingles at the apex of the roof, at a roof/wall intersection, the last course of nails will not be covered by an adjacent shingle and such uncovered nails are therefore exposed to the elements.

Exposed nails can also occur if nails are improperly installed on shingled roofs. When an installer nails shingles to a roof, there is a small zone on the shingles where the nails can be placed so that they will be covered by the next row of overlapping shingles. When nails are installed below this zone, those nails will not be covered by the succeeding row of shingles. They will remain visible and can cause leaking.

If left exposed, all such uncovered nails will corrode to the point that they may lose their grip or hold on the respective shingles that they are securing to the roof structure.

Shingled roofs are also subject to a wide variety of weather-related damage including hail damage, storm damage, wind damage and the like. In the particular case of hail damage, or any other damage to a particular asphalt shingle, the present methods for replacing damaged shingles are labor-intensive, time consuming and not very cost-effective, particularly, if the damaged shingles are located in the center portion of the roof structure. Current replacement methods typically require a roofer to remove the damaged shingles. Such repair also then requires removal or at least lifting and separating surrounding shingles since shingled roofs are laid in an overlapping fashion as explained above. Because replacing individual shingles is time consuming, labor-intensive, and may even cause damage to surrounding shingles, there does exist a need for a better, less labor-intensive, and faster system for repairing damaged asphalt shingles without necessarily removing the damaged shingle.

In view of the foregoing, it will be apparent to those skilled in the art that a need exists for a shingle patch for hail damage repair of asphalt shingles as well as patches for covering exposed nail heads. The present invention addresses this need as well as other needs which will become apparent to those skilled in the art after reading the present disclosure.

### SUMMARY OF THE INVENTION

The present invention is directed to several embodiments of a shingle patch system which can be used to repair hail damage and any other shingle damage associated with asphalt shingles and which can be used to cover exposed nails.

In one aspect of the present invention, several embodiments of a shingle patch are disclosed wherein the patch can be overlaid on top of a damaged asphalt shingle such as a shingle having weather damage thereby eliminating the need for totally removing the damaged shingle. One embodiment of the present shingle patch includes a patch base member having one end portion of the base member specifically structured for sliding under an existing shingle such as the shingle located immediately above the damaged shingle, whereas the opposite end portion of the present shingle patch base member includes a roof nail built into the patch itself. The top portion of the base member includes colored granules that are embedded into the patch so as to match the color of the existing damaged shingle. In this regard, the present patch can be produced in multiple colors so as to match the known existing asphalt shingle colors in the marketplace, or the patch can be manufactured on site in the field by using a pre-made patch base member as will be hereinafter further explained and thereafter affixing colored granules to the patch base member in the field so as to match the existing colors of the roof to be repaired.

A sealant is associated with the bottom portion of the shingle patch base member and with that portion of the patch base member to be inserted under the existing shingle located above the damaged shingle. This sealant is preferably heat activated and can be factory applied and is typically activated by the sun. A cellophane tape or other material can be placed over the sealant areas so as to prevent the sealant from binding to any other material during shipment and storage. The tape is removed prior to installing the shingle patch over the damaged shingle. In this regard, a technician will lift the bottom edge of the shingle that lies just one row above the damaged shingle, remove the release tape from that portion of the shingle patch that slides under the existing shingle, and then insert that portion of the shingle patch under the raised shingle. The raised shingle is then lowered onto that portion of the shingle patch and that portion of the patch will bind to the existing shingle through the sealant. Once inserted under the existing adjacent shingle, the bottom portion of the shingle patch may also seal directly to the damaged shingle via the sealant located on the bottom portion of the present patch upon removing the tape previously covering the sealant of the bottom surface. Once inserted under the existing adjacent shingle, the opposite end portion of the shingle patch housing the integrated roof nail is then nailed to the damaged shingle thereby allowing the under surface of the shingle patch to seal directly to the damaged shingle via the sealant located on the bottom portion of the present patch. Once complete, the present shingle patch will overlay the damaged shingle and will match the color scheme of the roof. Since the damaged shingle remains in place, the present shingle patch provides a double layer of protection over the damaged shingle since the damaged shingle still provides some protection to the roof structure.

In another embodiment of the present shingle patch, the patch base member again includes one end portion that slides under an existing shingle, colored granules embedded in its top surface to match the color scheme of the roof shingle to be repaired, and a sealant covering both that portion of the base member which again slides under the existing shingle as well as covering the bottom surface of the base member. In contrast to the other embodiment of the present shingle patch, this patch embodiment includes a flap portion at its opposite end portion, the flap portion being lifted so that a standard roof nail can be nailed through the corresponding mating surface of the base member into the underlying damaged shingle. In this particular embodiment, an integrated roof nail is not associated with the patch. Instead, the inner surface of the flap portion and its corresponding mating surface are likewise covered with a sealant and both surfaces are likewise covered with a cellophane tape or other release tape to prevent such mating surfaces from bonding together until required. This embodiment of the present patch is again inserted under an existing shingle located immediately above the damaged shingle and once so inserted, the flap portion at the opposite end portion of the base member is lifted, the release tape is removed and a standard roof nail is then nailed through the mating surface of the base member located under the flap portion and through the damaged shingle located below. Once the standard roof nail is hammered into place, the flap portion is lowered such that the flap will cover the head of the standard roof nail just hammered into place. As such, the flap portion serves as a roof nail seal and completely covers the nail head thereby preventing exposure to the elements. The sealant located on the bottom surface of the shingle patch as well as on the mating flap areas and on the area that slides under the existing shingle are all preferably activated either by the sun or by other heat sources thereby bonding the shingle patch to the existing shingle, the damaged shingle and to various portions of the patch itself. Here again, this embodiment of the present shingle patch overlays the damaged shingle and provides an extra layer of protection to the roof structure.

In a separate embodiment substantially similar to the first embodiment described above, the nail integrated into the roofing patch is omitted. Instead the sealant located on the bottom surface of the base member is sufficient in and of itself to secure the shingle patch to a damaged asphalt shingle and the one end portion that slides under an existing shingle, in an alternative embodiment, includes a tapered surface.

In yet another embodiment of the present shingle patch, the patch is made up of two separate parts and again includes no nails. The shingle patch includes each an upper base member and a lower base member. The lower base member again includes one end portion that slides under an existing shingle just above the damaged shingle in need of repair. A sealant covers both its upper surface and its bottom surface. Both surfaces are likewise covered with a cellophane tape or other release tape to prevent them from bonding together or with other materials until desired. The top portion of the upper base member again includes colored granules that are embedded into its surface so as to match the color of the existing damaged shingle. Thus, like the single patch designs, the two-piece patch can be produced in multiple colors so as to match the known existing asphalt shingle colors in the marketplace, or the patch can be manufactured on site in the field by using a pre-made patch base member as will be hereinafter further explained and thereafter affixing colored granules to the patch upper base member in the field so as to match the existing colors of the roof to be repaired. A sealant covers the lower surface of the upper base member, and a cellophane tape or other release tape is provided on the lower surface to prevent it from bonding with the lower base member until required.

This embodiment of the present patch involves inserting the lower base member under an existing shingle located immediately above the damaged shingle. In this regard, a technician will again lift the bottom edge of the shingle just one row above the damaged shingle and remove the release tape from an end portion of the upper surface of the lower base member. The end portion of the lower base member may then slide under the existing, raised shingle. The raised shingle is then lowered onto that end portion of the shingle patch and that portion of the patch will bind to the existing shingle through the sealant. Once inserted under the existing adjacent shingle, the lower base member may also seal directly to the damaged shingle via the sealant located on the bottom portion of the lower base member (after tape associated therewith is removed). Subsequently, tape may be removed from the lower surface of the upper base member and the remaining upper surface of the lower base member before overlaying the upper base member on the lower base member. Sealant on the upper surface of the lower base member not located under the shingle one row above the damaged shingle may then adhere to sealant on the lower surface of the upper base member. With the upper and lower base members adhered to one another, the two-piece shingle patch will overlay the damaged shingle and will match the color scheme of the roof. This two-piece shingle patch provides a triple layer of protection over the damaged shingle since the damaged shingle still provides some protection to the roof structure.

Other embodiments include eliminating that portion of the present shingle patch that is inserted under the existing shingle located immediately above the damaged shingle and merely abutting one end portion of the present shingle patch with the edge of the existing shingle located immediately above the damaged shingle; folding the present shingle patches without notches to overlay the exposed nails associated with the last row of ridge cap shingles; modifying the present shingle patches to overlay exposed nails associated with a roof/wall intersection or shed roof; modifying a staggered butt design shingle to serve as a patch for covering exposed nails; creating an improved starter shingle and seam cover patch; and utilizing a double sided adhesive tape to form both that portion of a patch that is inserted under an existing shingle and an entire patch itself.

The various embodiments of the present shingle patch provide an improved roof repair system for repairing and/or replacing damaged shingles due to severe weather damage such as hail and the like as well as for covering exposed nails wherever they may exist on a shingled roof. These and other specific aspects and advantages of the present embodiments will be apparent to those skilled in the art after reviewing the following detailed description of the illustrative embodiments set forth below which, taken in conjunction with the accompanying drawings, disclose improved structures for the roofing industry.

### BRIEF DESCRIPTION OF THE DRAWINGS

FIG. 1 is a top plan form view of one embodiment of the present shingle patch constructed in accordance with the teachings of the present invention.

FIG. 2 is a side elevational view of the shingle patch of FIG. 1.

FIG. 3 is a side elevational view of a typical shingled roof showing the overlaying pattern arrangement of shingles before the present shingle patch is applied for repair.

FIG. 4 is a side elevational view similar to FIG. 3 showing the present shingle patch of FIGS. 1 and 2 in exploded view prior to insertion for repair.

FIG. 5 is a side elevational view similar to FIG. 4 showing the present shingle patch of FIGS. 1 and 2 positioned and attached to the existing roof structure and overlaying the damaged shingle.

FIG. 6 is a side elevational view of another embodiment of the present shingle patch constructed in accordance with the teachings of the present invention.

FIG. 7 is a perspective view of an alternative embodiment of the shingle patches of FIGS. 1 and 6 constructed in accordance with the teachings of the present invention.

FIG. 8 is a side elevational view of the shingle patch of FIG. 7.

FIG. 8A is a side elevational view of another embodiment of a shingle patch similar to FIGS. 7 and 8 showing a tapered notched portion.

FIG. 9 is an exploded perspective view of a two-piece embodiment of the present shingle patch constructed in accordance with the teachings of the present invention.

FIG. 10 is a side elevational view of the two pieces that make up the shingle patch of FIG. 9.

FIG. 11 is a side elevational view of still another embodiment of a shingle patch similar to the shingle patch of FIGS. 7 and 8 constructed in accordance with the teachings of the present invention.

FIG. 12 is a side elevational view of still another embodiment of a two-piece shingle patch similar to the shingle patch of FIGS. 9 and 10 constructed according to the teachings of the present invention.

FIG. 13 is a side elevational view of yet another embodiment of a one-piece shingle patch constructed according to the teachings of the present invention.

FIG. 14 is a side elevational view of yet another embodiment of a two-piece shingle patch constructed according to the teachings of the present invention.

FIG. 15 is an exploded perspective view of yet another embodiment of a one-piece shingle patch constructed specifically to cover the exposed nails associated with the last ridge cap shingle placed at the peak or apex of a roof.

FIGS. 16A and 16B are a top plan form view and a side elevational view of a starter shingle constructed according to the teachings of the present invention.

FIGS. 17A and 17B is a bottom plan form view and a side elevational view of the starter shingle of FIGS. 16A and 16B.

FIGS. 18A and 18B are a bottom plan form view and a side elevational view of an alternative embodiment of the starter shingle of FIGS. 17A and 17B.

FIG. 19 is a partial perspective view of a roof structure showing two starter shingles in side-by-side relationship along the lower edge of the roof structure.

FIG. 20 is a side elevational view of another embodiment of a one-piece shingle patch configured specifically for covering the exposed seem associated with the two side-by-side starter shingles illustrated in FIG. 19.

FIG. 21 is a partial perspective view similar to FIG. 19 showing the shingle patch seam cover member of FIG. 20 in position overlaying the seam formed between the two side-by-side starter shingles of FIG. 19.

FIGS. 22 and 24 are exploded perspective views of yet another embodiment of a one-piece shingle patch constructed according to the teachings of the present invention for specifically covering exposed nails associated with shingles or flashing installed on slopes that terminate against a wall or projection such as chimneys, solar panels and so forth, or the last row of shingles on a shed roof.

FIG. 23 is a perspective view of yet another embodiment of a one-piece shingle patch constructed according to the teachings of the present invention wherein a staggered butt shingle is used for covering exposed nails associated with shingles that terminate at a roof/wall intersection, or the last row of shingles on a shed roof.

FIG. 25 is an exploded perspective view of still another embodiment of a one-piece shingle patch constructed according to the teachings of the present invention.

FIG. 26 is a side elevational view of the shingle patch of FIG. 25.

FIG. 27 is a side elevational view of another embodiment of the shingle patch of FIG. 26.

FIG. 28 is a side elevational view illustrating the partial removal of the release tape associated with the shingle patch of FIG. 27, the release tape being folded under the bottom portion of the shingle patch.

FIG. 29 is a side elevational view of still another embodiment of a shingle patch without a notched portion.

FIG. 30 is a side elevational view of yet another embodiment of a one-piece shingle patch similar to FIG. 29 except that one side edge portion of the base member includes an adhesive layer.

FIG. 31 is a side elevational view of a double sided adhesive tape used to form the shingle patch of FIG. 32.

FIG. 32 is a side elevational view of another embodiment of a one-piece shingle patch formed solely from the double sided adhesive tape of FIG. 31.

### DETAILED DESCRIPTION OF THE INVENTION

Several embodiments of the present invention will now be explained with reference to the accompanying drawings. It will be apparent to those skilled in the art from this disclosure that the following description of the various embodiments of the present invention is provided for illustration purposes only and not for the purpose of limiting the present invention as defined by the appended claims and their equivalents.

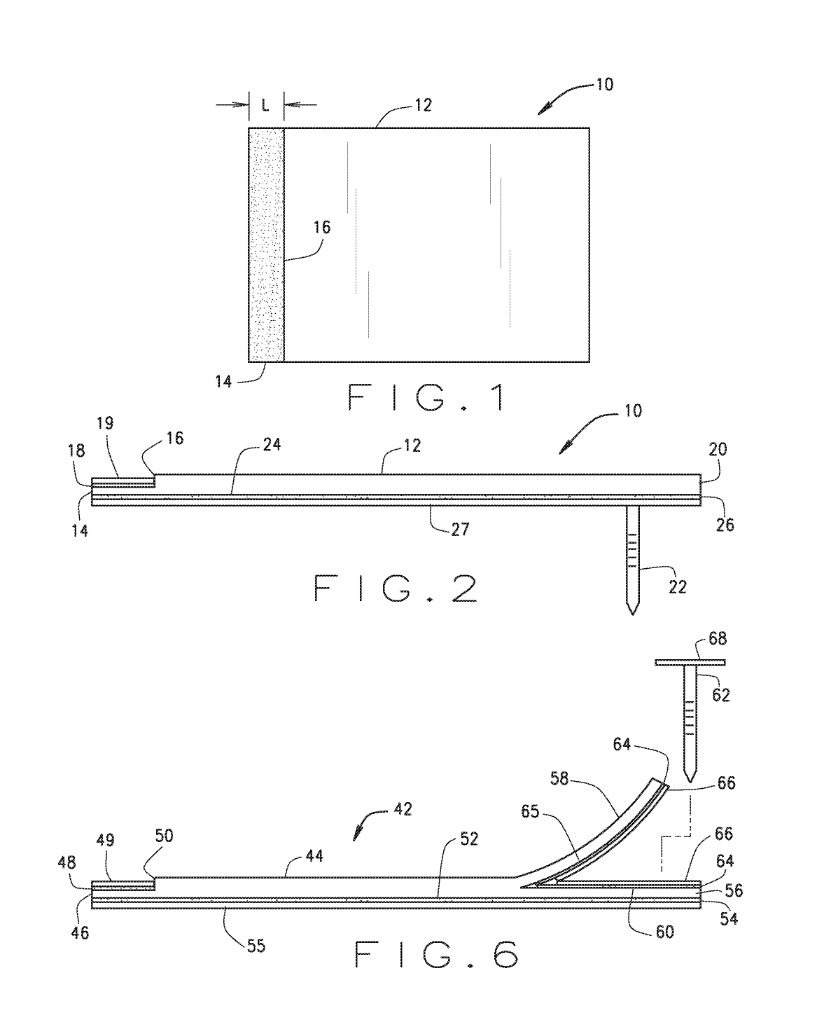

Referring to the drawings more particularly by reference numbers wherein like numbers refer to like parts, the number 10 in FIGS. 1 and 2 refers to one embodiment of a shingle patch used to repair damaged asphalt shingles constructed in accordance with the teachings of the present application. The shingle patch 10 includes a base member 12 sized and shaped similarly to a conventional asphalt shingle or smaller depending upon the particular application, one end portion which includes a notched portion 14 which is specifically shaped and designed for sliding under an existing shingle, such as the shingle located immediately above the damaged shingle, as will be hereinafter further explained. The notched portion 14 of base member 12 includes an overall height or thickness which is less than the overall height or thickness of the remainder of base member 12 as clearly illustrated in FIG. 2. The notched portion 14 is sized so as to be inserted under an existing shingle located immediately above the damaged shingle such that at least a portion of the existing shingle will mate with and rest on top of notched portion 14. Notched portion 14 is thinner than the remainder of base member 12 to likewise avoid creating a hump under the existing shingle when it is overlaid on top of notched portion 14. A wall or ledge portion 16 (FIG. 2) is formed between notched portion 14 and the remainder of base member 12 and functions as a stop or abutment surface for the existing shingle when overlaid on top of notched portion 14 thereby limiting the travel of the existing shingle when the notched portion 14 is inserted under the existing shingle. This arrangement also helps to prevent rain water from infiltrating under the patch 10. The overall length L of notched portion 14 can be varied depending upon the particular application and depending upon the particular size and style of asphalt shingles to be repaired.

The notched portion 14 also includes a sealant and/or adhesive 18 distributed across at least a portion of its upper surface as best illustrated in FIG. 2 for mating with and attaching to the undersurface of the existing shingle when the existing shingle is overlaid on top of notched portion 14. The sealant 18 is preferably a heat activated sealant which can be factory applied and is typically activated by the sun, although other heat sources can be applied to the notched portion 14 to activate the sealant material. Preferably, the sealant 18 covers the entire upper surface of the notched portion 14. A cellophane tape or other release material 19 can be placed over the sealant 18 so as to prevent the sealant from binding to any other material or object during shipment and storage. The tape 19 is removed prior to installing the shingle patch 10 as will be hereinafter further explained.

The opposite end portion 20 of base member 12 includes a roofing nail 22 built into the base member 12. Roofing nail 22 can be any known conventional roofing nail suitable for asphalt shingles. The roofing nail 22 is attached or integrally formed with the shingle patch base member 12 during the manufacturing process or, nail 22 can be otherwise attached to member 12 after the manufacturing process so long as nail 22 and base member 12 form a one-piece unit.

A sealant 26 is likewise associated with at least a portion of the bottom surface 24 of base member 12 as best illustrated in FIG. 2. Similar to sealant 18, sealant 26 is preferably a heat activated sealant and is likewise preferably factory applied and is typically activated by the sun. Here again, sealant 26 preferably covers the entire bottom surface 24 of base member 12. A cellophane tape or other material 27 is likewise placed over sealant 26 so as to again prevent the sealant from binding to any other material or object during shipment and storage. The tape 27 is removed prior to installing the shingle patch 10 over a damaged shingle as will be hereinafter further explained.

The top portion of base member 12 includes colored granules (not shown) that are embedded into the patch material so as to match the color of the existing damaged shingle to be repaired. In this regard, the present shingle patch 10 can be produced in multiple colors so as to match the known existing asphalt shingle colors present in the marketplace, or the base member 12 can be color-coordinated with the shingles to be repaired on-site in the field by using a pre-made shingle base member 12 with no color granules associated therewith and thereafter affixing colored granules to the member 12 in the field so as to match the existing colors of the roof to be repaired. Colored granules can be applied to any portion or the entire top surface of base member 12 in a known conventional manner using appropriate adhesives and/or other sealing materials.

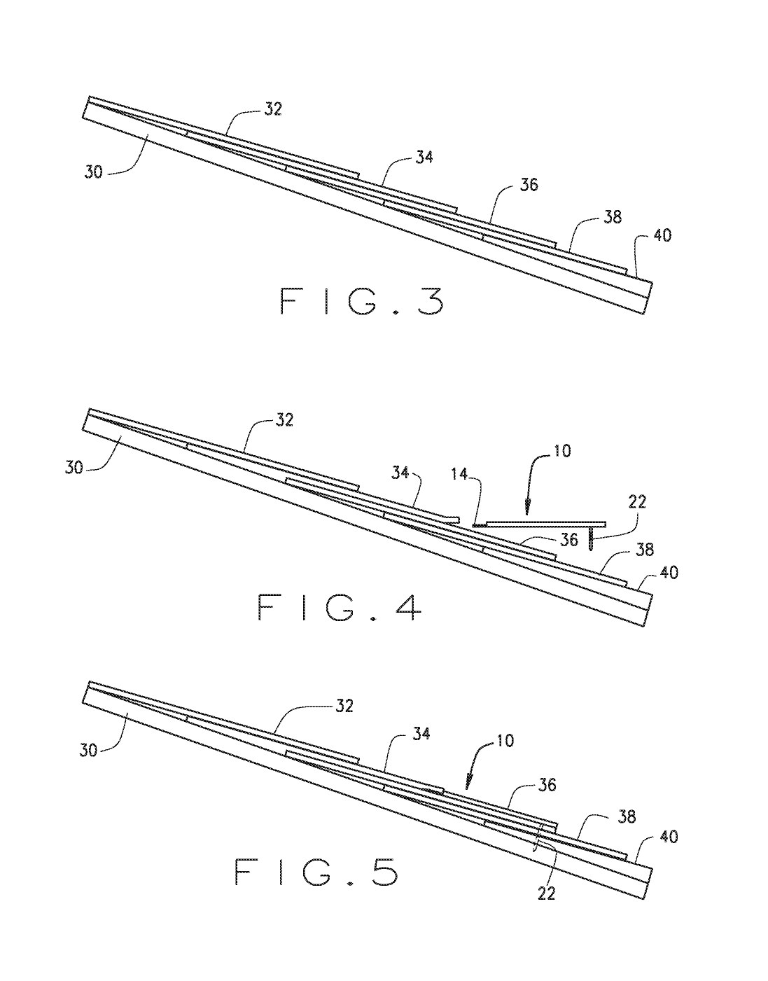

FIG. 3 illustrates a typical asphalt shingled roof wherein the underlying roof structure 30 is typically plywood or some other wood product. Typical asphalt shingles 32, 34, 36, 38 and 40 are overlaid in a typical overlapping pattern as illustrated in FIG. 3. Assuming that asphalt shingle 36 is damaged by hail or any other weather event, FIGS. 4 and 5 illustrate the method for repairing damaged asphalt shingle 36 using the present shingle patch 10. Repair will typically begin as illustrated in FIG. 4 where a technician will lift the bottom edge of the shingle that lies immediately above the damaged shingle. As illustrated in FIG. 4, the bottom edge of shingle 34 lies just one row above the damaged shingle 36. Lifting of the bottom edge of shingle 34 can be accomplished with known tools in the trade. Once the bottom edge of shingle 34 is lifted as illustrated, the technician will remove the release tape 19 and 27 associated with notched portion 14 and the bottom surface 24 of base member 12 respectively and then slide notched portion 14 of base member 12 under the raised portion of shingle 34. The raised shingle portion of shingle 34 is then lowered onto notched portion 14 and the heat activated or other sealant 18 associated therewith. As stated, prior to inserting notched portion 14 under the raised shingle 34, the release tape 27 associated with the bottom portion 24 of shingle patch 10 is likewise removed prior to installation.

Once notched portion 14 is inserted under the existing adjacent shingle 34, the opposite end portion 20 of base member 12 housing the integrated roofing nail 22 is then nailed to the damaged shingle 36 as best illustrated in FIG. 5. Once nailed, the undersurface of base member 12 is sealed directly to the damaged shingle 36 via the sealant 26 located across its bottom surface. Once completed, the shingle patch 10 will overlay the damaged shingle 36 as illustrated in FIG. 5 and the colored granules associated with the top surface of base member 12 will match the color scheme of the other shingles 32, 34, 36, 38 and 40 associated with the roof structure. The heat activated sealant 18 and 26 will bind to their respective mating surfaces by the heat generated from the sun if a heat activated sealant is used. Other heat sources can be used to immediately activate the sealant 18 and 26 if so desired. This could include using heat blowers, or using a different type of sealant. Since the damaged shingle 36 remains in place, the present shingle patch 10 provides an extra layer of protection since the damaged shingle 36 still provides some protection to the roof structure. Depending upon the size of the damaged area associated with shingle 36, shingle patch 10 can be sized and dimensioned so as to adequately overlay the damaged area of shingle 36. In this regard, shingle patch 10 can merely cover a portion of shingle 36 or, in other embodiments, it can cover substantially all of shingle 36 if so desired. Shingle patch 10 can be made according to any dimensions up to and including covering the entire damaged asphalt shingle.

FIG. 6 illustrates another embodiment 42 of the present shingle patch, namely, shingle patch 42. Patch 42 includes as a base member 44 again having a notched portion 46 associated with one end portion thereof which is constructed substantially similar to notched portion 14 associated with shingle patch 10 including having a sealant 48 covering at least a portion of the upper surface of notched portion 46 and likewise including an abutment surface, ledge or stop portion 50 for positioning and overlaying the existing adjacent shingle which will be positioned on top of notched portion 46 as previously explained. Shingle patch 42 likewise includes colored granules (not shown) embedded into its top surface to match the color scheme of the roof shingles to be repaired, and a sealant 54 covering at least a portion of the bottom surface 52 of base member 44 similar to sealant 26 associated with shingle patch 10.

Shingle patch 42 differs from shingle patch 10 in that it does not include an integrated roofing nail. Instead, the opposite end portion 56 of base member 44 includes a flap portion 58 that can be moved or lifted away from its mating surface 60 as best illustrated in FIG. 6 so that a standard roofing nail 62 can be nailed through the mating surface 60 of base member 44 into the underlying damaged shingle as will be hereinafter explained. The flap portion 58 includes a sealant 64 associated with its inner surface 65 and its mating base portion 60 can likewise optionally include a sealant 64 as well for mating with and sealing with flap portion 58. Both flap surfaces 65 and 60 covered with a sealant 64 are likewise covered with a cellophane tape or other release tape 66 so as to prevent these mating surfaces from bonding together until required. Again, sealant 64 can be a heat activated sealant. Flap portion 58 should be sufficiently large enough so as to allow a roofing technician to hammer a conventional roofing nail through base member mating surface 60 and end portion 56 so as to complete the attachment of shingle patch 42 to the damaged shingle.

Shingle patch 42 is attached overlaying a damaged shingle in a manner substantially similar to shingle patch 10 as illustrated and discussed with respect to FIGS. 3-5. In this regard, the notched portion 46 of shingle patch 42 is again inserted under an existing shingle located immediately above the damaged shingle as discussed above with respect to shingle patch 10. Here again, the release tape 49 covering sealant 48 is removed prior to insertion under the existing shingle. In similar fashion, the release tape 55 associated with sealant 54 is likewise removed prior to insertion of the notched portion 46 under the existing shingle located immediately above the damaged shingle to be repaired. Once the notched portion 46 is properly positioned, shingle patch 42 is lowered and positioned so as to overlay the damaged area of the damaged shingle and the sealant 54 associated with the bottom surface 52 of shingle patch 42 is then allowed to seal directly to the damaged shingle via the sealant 54 as previously explained. At this point, the flap portion 58 is lifted, the release tape 66 associated with both sealant surfaces 64 is removed and a standard roofing nail 62 is then nailed through the mating surface 60 of base member 44 and through the damaged shingle located below. Once the standard roofing nail 62 is hammered into place, the flap portion 58 is lowered and the sealant 64 associated with flap portion 58 and/or mating surface 60 are allowed to bond as previously explained.

Importantly, flap portion 58 covers the head 68 of roofing nail 62 and serves as a seal thereby preventing the roofing nail 62 from being exposed to the elements. Again, the respective heat activated sealants 48, 54 and 64, if used, can all be activated either by the sun or by other heat sources thereby bonding the shingle patch 42 to the existing damaged shingle, the adjacent existing shingle, and the various portions of the mating flap portion 58. Here again, shingle patch 42 overlays the damaged shingle and provides an extra layer of protection to the roof structure. The method of positioning and attaching the shingle patch 42 over a damaged shingle is substantially identical to the procedure outlined with respect to shingle patch 10 as illustrated in FIGS. 3-5 except for using a standard roofing nail 62 as explained above. Like shingle patch 10, shingle patch 42 can be sized and dimensioned as previously explained and depending upon the particular application.

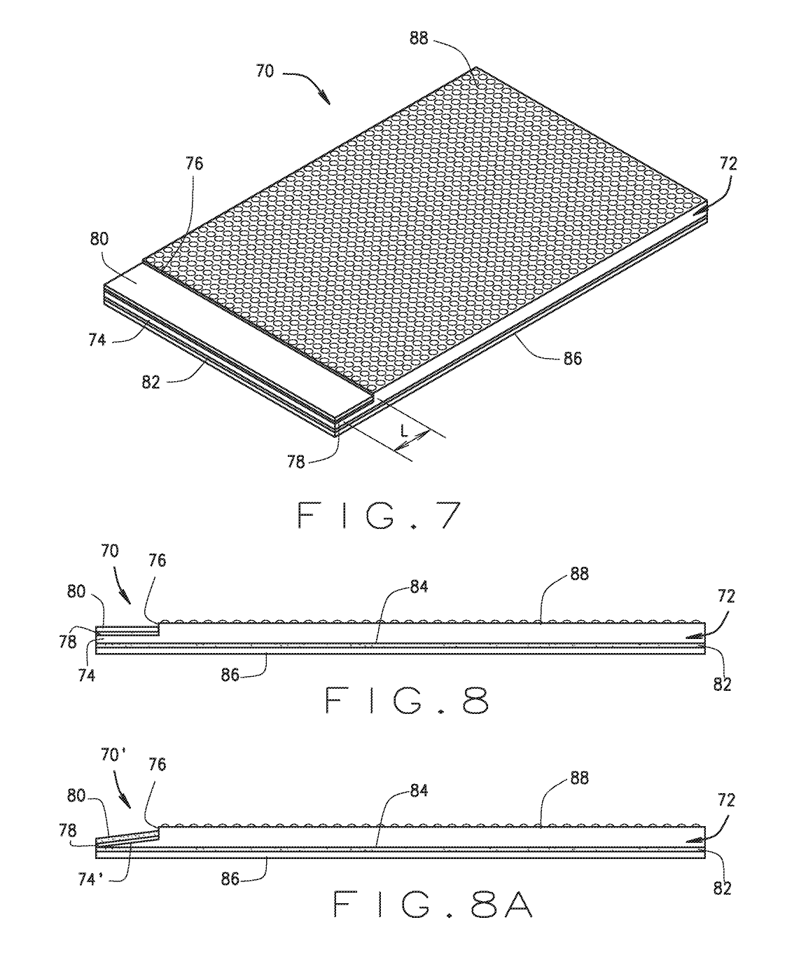

FIGS. 7 and 8 refer to another embodiment of a shingle patch 70 used to repair damaged asphalt shingles constructed in accordance with the teachings of the present application. The shingle patch 70 is substantially similar to the shingle patch 10 described above, though the shingle patch 70 does not include a nail like roofing nail 22 described and shown above. Like the shingle patch 10, the shingle patch 70 includes a base member 72 sized and shaped similarly to a conventional asphalt shingle or smaller depending upon the particular application. The base member 72 includes one end portion which includes a notched portion 74 specifically shaped and designed for sliding under an existing shingle, such as the shingle located immediately above the damaged shingle, as described above. The notched portion 74 of base member 72 also includes an overall height or thickness which is less than the overall height or thickness of the remainder of base member 72 as clearly illustrated in FIG. 8. The notched portion 74 is sized so as to be inserted under an existing shingle located immediately above the damaged shingle such that at least a portion of the existing shingle will mate with and rest on top of notched portion 74 in a manner substantially similar to the notched portion 14 of the shingle patch 10. Notched portion 74 is thinner than the remainder of base member 72 to likewise avoid creating a hump under the existing shingle when it is overlaid on top of notched portion 74. A wall or ledge portion 76 (FIG. 8) is formed between notched portion 74 and the remainder of base member 72 and functions as a stop or abutment surface for the existing shingle when overlaid on top of notched portion 74 thereby limiting the travel of the existing shingle when the notched portion 74 is inserted under the existing shingle. This arrangement also helps to prevent rain water from infiltrating under the patch 70. The overall length L of notched portion 74 can be varied depending upon the particular application and depending upon the particular size and style of asphalt shingles to be repaired.

The notched portion 74 also includes a sealant and/or adhesive 78 distributed across at least a portion of its upper surface as best illustrated in FIG. 8 for mating with and attaching to the undersurface of the existing shingle when the existing shingle is overlaid on top of notched portion 74. The sealant 78 is preferably a heat activated sealant which can be factory applied and is typically activated by the sun, although other heat sources can be applied to the notched portion 74 to activate the sealant material. Preferably, the sealant 78 covers the entire upper surface of the notched portion 74. A cellophane tape or other release material 80 can be placed over the sealant 78 so as to prevent the sealant from binding to any other material or object during shipment and storage. The tape 80 is removed prior to installing the shingle patch 70 as will be hereinafter further explained.

A sealant 82 is likewise associated with at least a portion of a bottom surface 84 of base member 72 as best illustrated in FIG. 8. Similar to sealant 78, sealant 82 is preferably a heat activated sealant and is likewise preferably factory applied and is typically activated by the sun or by other mechanical heat source means such as a heat blower. Here again, sealant 82 preferably covers the entire bottom surface 84 of base member 72. A cellophane tape or other material 86 is likewise placed over sealant 82 so as to again prevent the sealant from binding to any other material or object during shipment and storage. The tape 86 is removed prior to installing the shingle patch 70 over a damaged shingle as will be hereinafter further explained.

The top portion of base member 72 again includes colored granules 88 that are embedded into the patch material so as to match the color of the existing damaged shingle to be repaired. In this regard, the present shingle patch 70 can be produced in multiple colors so as to match the known existing asphalt shingle colors present in the marketplace. In an alternative embodiment such as shown for the base member 12 of the shingle patch 10, the base member 72 can be color-coordinated with the shingles to be repaired on-site in the field by using a pre-made shingle base member with no color granules associated therewith and thereafter affixing colored granules to the member 72 in the field so as to match the existing colors of the roof to be repaired. Colored granules can be applied to any portion or the entire top surface of base member 72 in a known conventional manner using appropriate adhesives and/or other sealing materials.

The shingle patch 70 may be fitted to and adhered to a damaged shingle in a manner substantially similar to that described for shingle patch 10 and shown in FIGS. 3-5 except it does not use the roofing nail 22 to nail the shingle patch 70 to the damaged shingle 36. Instead the sealant 82 on the bottom surface 84 of the base member 72 provides sufficient adhesive force to bond the shingle patch 70 to the damaged shingle 36. The roofing nail 22 is not necessary.

It is also recognized and anticipated that a factory or field applied adhesive that is aggressive enough to be applied at acceptable, ambient temperature using only sufficient downward pressure to laminate or attached the patch 70 to the existing roof can also be utilized. A small roller tool made from metal, rubber, wood or other similar material can be used to apply a concentrated pressure to the patch 70 to ensure adequate attachment. This attachment should provide a permanent waterproof bonding between the patch 70 and the existing roof. Other adhesives or sealants may also be used.

The patch 70 can be trimmed to fit the particular application at the factory, or by the installer in the field, to repair shingles of different shapes and sizes as well as lip and ridge and any other accessory products. The patch 70 is installed without nails as the adhesives alone provides the permanent and waterproof bonding together of all surfaces. The patch 70 can also be used to cover exposed nails such as those that exist as a result of headwalls, the final rows of field shingles on shed roof style roofs, on final ridge caps, and other applications.

FIG. 8A refers to yet another embodiment of a shingle patch 70′ used to repair damaged asphalt shingles wherein the shingle patch 70′ is substantially similar to shingle patch 70 except that the notched portion 74′ is tapered as shown. Like shingle patch 70, shingle patch 70′ includes a base member 72 now having a tapered notch portion 74′ associated with one end portion thereof, the tapered notched portion 74′ more easily facilitating the sliding of the notched portion 74′ under an existing shingle such as the shingle located immediately above the damaged shingle as previously described. Again, the notched portion 74′ includes an overall height or thickness which is less than the overall height or thickness of the remainder of the base member 72 and includes a sealant and/or adhesive 78 distributed across at least a portion of its upper surface for mating with and attaching to the undersurface of the existing shingle when the existing shingle is overlaid on top of notched portion 74′. The sealant 78 is as previously described above. A cellophane tape or other release material 80 can likewise be placed over the sealant 78 so as to prevent the sealant from binding to any other material or object during shipment and storage. The top portion of base member 72 again can include colored granules 88 that are embedded into the patch material so as to match the color of the existing damaged shingle to be repaired as previously described. In all other respects, the shingle patch 70′ is substantially similar to shingle patch 70 and can likewise be trimmed to fit the particular application at the factory, or by the installer in the field, to repair shingles of different shapes and sizes as well as lip and ridge and other accessory products. The patch 70′ is likewise installed without nails as the adhesives alone provide the permanent and waterproofing bonding together of all surfaces. The shingle patch 70′ has all of the same applications as shingle patch 70 previously described including being used to overlay exposed nails associated with a roof structure.

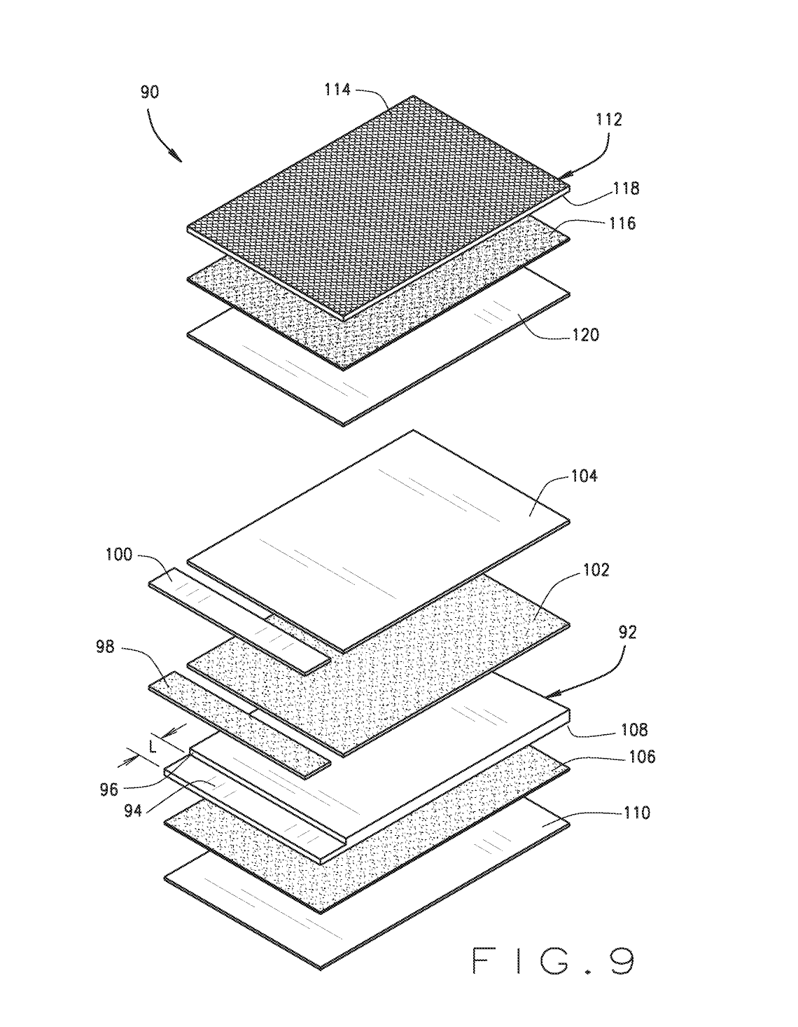

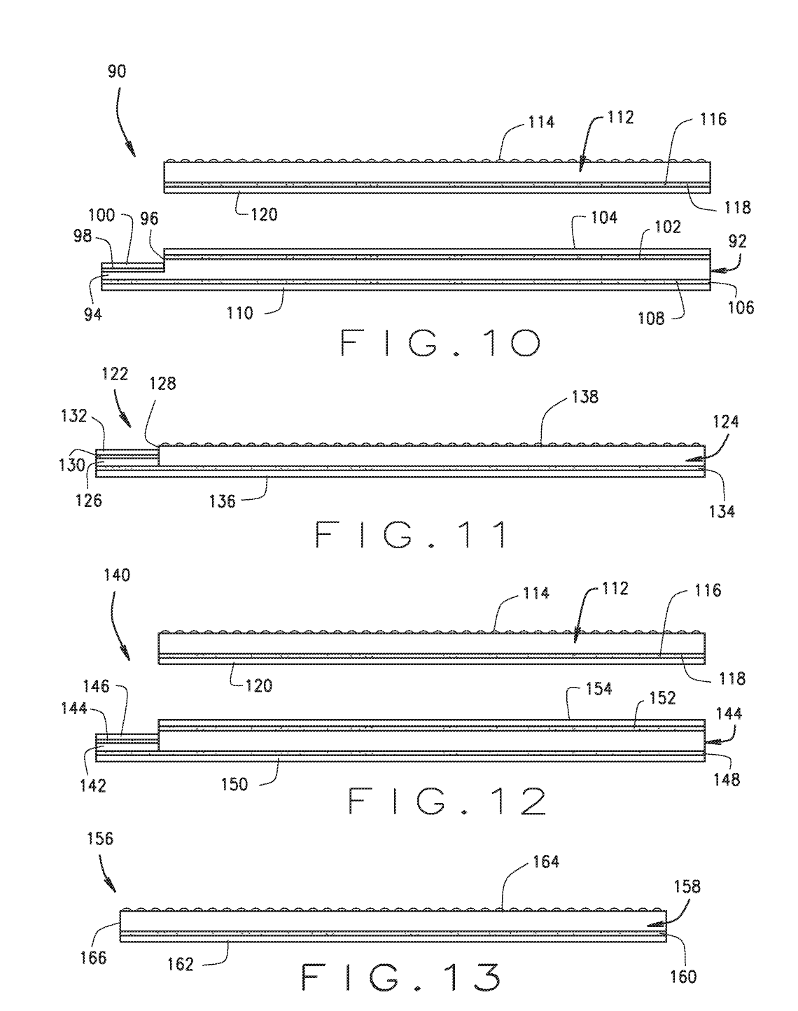

Turning now to FIGS. 9 and 10, yet another embodiment of a shingle patch 90 is provided that likewise is used to repair damaged asphalt shingles constructed in accordance with the teachings of the present application. The shingle patch 90, like the shingle patch 70, does not include a nail like roofing nail 22 described and shown herein in reference to the shingle patch 10. However, the shingle patch 90 does include two parts, each of which are described in detail below. The shingle patch 90 includes a lower base member 92 sized and shaped similarly to a conventional asphalt shingle or smaller depending upon the particular application. The lower base member 92 includes one end portion having a notched portion 94 specifically shaped and designed for sliding under an existing shingle, such as the shingle located immediately above the damaged shingle, as described above in relation to the other shingle patches 10, 70. The notched portion 94 of lower base member 92 also includes an overall height or thickness less than the overall height or thickness of the remainder of lower base member 92 as clearly illustrated in FIG. 10. Like the notched portion 74, the notched portion 94 is thinner than the remainder of lower base member 92 to likewise avoid creating a hump under the existing shingle when it is overlaid on top of notched portion 94. A wall or ledge portion 96 shown in FIGS. 9 and 10 is also provided that performs substantially the same function as the ledge portions associated with the shingle patches 10, 70. The ledge portion 96 limits the travel of the existing shingle when the notched portion 94 is inserted under the existing shingle. This arrangement also helps to prevent rain water from infiltrating under the patch 90. The overall length L of notched portion 94 can, like the other shingle patches 10 and 70, be varied depending upon the particular application and depending upon the particular size and style of asphalt shingles to be repaired.

The notched portion 94 also includes a sealant and/or adhesive 98 distributed across at least a portion of its upper surface as best illustrated in FIG. 9 for mating with and attaching to the undersurface of the existing shingle when the existing shingle is overlaid on top of notched portion 94. The sealant 98 is preferably a heat activated sealant which can be factory applied and is typically activated by the sun, although other heat sources can be applied to the notched portion 94 to activate the sealant material. Preferably, the sealant 98 covers the entire upper surface of the notched portion 94. A cellophane tape or other release material 100 can be placed over the sealant 98 so as to prevent the sealant from binding to any other material or object during shipment and storage. The tape 100 is removed prior to installing the shingle patch 90 as will be hereinafter further explained.

Unlike the other shingle patches 10, 70, the upper portion of the lower base member 92 not including the notched portion 94 is also provided with a sealant and/or adhesive 102 distributed across at least a portion of its upper surface (best illustrated in FIG. 9) for mating with and attaching to the undersurface of an upper base member, the structure of which is described in greater detail below. The sealant 102 is preferably heat activated like the sealant 98 and covers the entirety of the upper surface of the lower body member 92 not including the notched portion 94. A cellophane tape or other release material 104 may also be placed over the sealant 102 so as to prevent the sealant 102 from binding to any other material or object during shipment and storage. The tape 104 is removed prior to attaching to the undersurface of the upper base member, the structure of which will be hereinafter further explained.

A sealant 106 is likewise associated with at least a portion of a bottom surface 108 of lower base member 92 as best illustrated in FIG. 10. The sealant 106 is substantially similar to the sealants 98, 102 described above and preferably covers the entire bottom surface 108 of lower base member 92. A cellophane tape or other material 110 is also placed over sealant 106 so as to again prevent the sealant from binding to any other material or object during shipment and storage. The tape 110 is removed prior to installing the lower base member 92 over a damaged shingle.

The shingle patch 90 further includes an upper base member 112 that is adhered to the lower base member 92 when the shingle patch 90 is assembled. The upper base member 112 preferably is sized and shaped substantially similarly to the upper surface of the lower base member 92 not including the notched portion 94. The top portion of upper base member 112 includes colored granules 114 that are embedded into the patch material so as to match the color of the existing damaged shingle to be repaired. In this regard, the present shingle patch 90 can be produced in multiple colors so as to match the known existing asphalt shingle colors present in the marketplace. In an alternative embodiment such as shown for the base member 12 of the shingle patch 10, the upper base member 112 can be color-coordinated with the shingles to be repaired on-site in the field by using a pre-made shingle base member with no color granules associated therewith and thereafter affixing colored granules to the upper base member 112 in the field so as to match the existing colors of the roof to be repaired. Colored granules can be applied to any portion or the entire top surface of base member 112 in a known conventional manner using appropriate adhesives and/or other sealing materials.

A sealant 116 is likewise associated with at least a portion of a bottom surface 118 of upper base member 112 as best illustrated in FIG. 10. The sealant 116 is substantially similar to the sealants 98, 102, 106 described above and preferably covers the entire bottom surface 118 of upper base member 112. A cellophane tape or other material 120 is also placed below sealant 116 so as to again prevent the sealant from binding to any other material or object during shipment and storage. The tape 120 is removed prior to attaching the upper base member 112 to the lower base member 92 to install the shingle patch 90.

The shingle patch 90 is fitted and adhered to a damaged shingle in a manner somewhat different than that described for shingle patch 10 and shown in FIGS. 3-5. Once the bottom edge of shingle 34 is lifted as illustrated in FIG. 4, a technician will again remove the release tape 100 and 110 associated with notched portion 94 and the bottom surface 108 of lower base member 92, respectively, and then slide notched portion 94 of lower base member 92 under the raised portion of shingle 34. The raised shingle portion of shingle 34 is then lowered onto notched portion 94 and the heat activated or other sealant 98 associated therewith. With the release tape 110 associated with the bottom portion 108 of the lower base member 92 removed, the sealant 106 may also be adhered to the damaged shingle, thus securing the lower base member 92 to the damaged shingle. Next, the sealing tape 104 covering remaining sealant 102 located on the upper surface of lower base member 92 may be removed. The sealing tape 120 covering the sealant 116 located on the bottom surface of upper base member 112 may likewise be removed, and the upper base member 112 may be attached to the lower base member 92 by way of the bond formed between sealants 116, 102 respectively.

Now assembled, the shingle patch 90 will overlay the damaged shingle 36 as illustrated in FIG. 5 and the colored granules 114 associated with the top surface of the upper base member 112 will match the color scheme of the other shingles such as shingles 32, 34, 36, 38 and 40 associated with the roof structure. The heat activated sealants 98, 102, 106, and 116 will bind to their respective mating surfaces by the heat generated from the sun, or other mechanical heat source means, if a heat activated sealant is used. Other heat sources can be used to immediately activate the sealants if so desired (e.g., using heat blowers or a different type of sealant).

It is also recognized and anticipated that the adhesives utilized with the bottom surface 108 of the lower base member 92, the upper surface of the lower base member 92, and the bottom surface 118 of the upper base member 112 may have different options for using adhesives that will supply a permanent and waterproof bonding both between the respective base members 92 and 112 as well as between the bottom surface 108 of lower base member 92 and the damaged shingle. These various options may include, for example, a factory or field applied adhesive that can be used with any of the above referenced surfaces that is aggressive enough to be applied at acceptable, ambient temperatures using only sufficient downward pressure so as to laminate or attach both the lower base member 92 to the damaged shingle and/or bonding the respective lower and upper base members 92 and 112 together. A small roller tool made from metal, rubber, wood or other suitable materials can be used to apply a concentrated pressure to the respective base members 92 and 112 to assure adequate attachment therebetween.

Still further, it is also recognized and anticipated that a factory or field applied adhesive that is sufficiently aggressive enough to bond to adjoining surfaces such as the bottom surface 118 of upper base member 112 to the upper surface of lower base member 92 may only need be applied to one of the two respective surfaces instead of applying an adhesive to both the bottom surface of upper base member 112 and the upper surface of lower base member 92. In this situation, only one of the respective surfaces need have an adhesive associated therewith.

The two-piece patch 90 can likewise be trimmed to fit the particular application at the factory, or it can be trimmed by the installer in the field, to repair shingles of different shapes and sizes as well as hip and ridge and other accessory products. Although the two-piece patch 90 is designed to be installed without nails as the adhesives associated with patch 90 alone provide the permanent and waterproof bonding necessary between all surfaces, patch 90 can likewise be utilized with nails. If nails are to be used, they will only be used on the lower base member 92 so that the upper base member 112 will then cover and seal all of the nail heads associated with the lower base member 92. The patch 90 can also be used to cover exposed nails such as those that exist as a result of headwalls, the final rows of field shingles on shed roof style roofs, on ridge caps, and on other applications.

It is also recognized and anticipated that the notched portion 74 associated with shingle patch 70 can also be formed by a very thin sheet of material such as a thin sheet of sheet metal, aluminum, copper, plastic or other suitable material which is merely attached to base member 72 via any suitable means of attachment such as a sealant, adhesive, or other attachment mechanism as best illustrated in FIG. 11. In this particular embodiment 122 (FIG. 11), shingle patch 122 is substantially similar to shingle patch 70 and includes a base member 124 having a thin sheet of material 126 associated with one end portion thereof which again is specifically shaped and designed for sliding under an existing shingle such as the shingle located immediately above the damaged shingle as described above. The sheet of material 126 can extend outwardly from one end portion of the base member 124 as illustrated in FIG. 11 or it can be overlapped with the bottom surface of the base member 124 and attached thereto in a conventional manner. The sheet of material 126 is relatively thin so that the existing shingle does not have to be lifted or separated from the roof structure nearly as much when the thin sheet of material 126 is inserted under the existing shingle located immediately above the damaged shingle as compared to inserting notch 74 under the existing shingle. This helps to preserve the seal between the existing shingle and the roof structure and further prevents leakage around the respective end portions of the existing shingle when the sheet of material 126 is inserted under such existing shingle. In all other respects, the shingle patch 122 is substantially similar to shingle patch 70 and includes a wall or lip portion 128, a sealant and/or adhesive 130 distributed across at least a portion of the upper surface of the thin sheet of material 126 for mating with and attaching to the undersurface of the existing shingle, a cellophane tape or other release material 132 placed over the sealant 130, a sealant 134 associated with at least a portion of the bottom surface of the base member 124, and a cellophane tape or other material 136 covering the sealant 134 as previously explained. The top portion of base member 124 again includes colored granules 138 that are embedded into or otherwise formed or attached to the patch material so as to match the color of the existing damaged shingle to be repaired.

Use of a thin sheet of material such as the sheet of material 126 can likewise be utilized with the lower base member 92 associated with the two-piece shingle patch 90 (FIGS. 9 and 10) as again illustrated in FIG. 12. In this particular embodiment 140, the notch 94 associated with the lower base member 92 is again replaced with a very thin piece of material 142. This again can be attached to the lower base member 144 via any suitable means as explained above. Here again, the thin piece of material 142 is shaped and designed to be inserted under the existing shingle located immediately above the damaged shingle and, because the sheet of material 142 is substantially thinner than the notched portion 94, insertion of the thin sheet of material 142 under the existing shingle requires less lifting of the existing shingle and thereby requires less deterioration of the seal between the existing shingle and the roof structure. As with embodiment 90, the thin sheet of material 142 may likewise include a sealant and/or adhesive 144 distributed across at least a portion of its upper surface as best shown in FIG. 12 and it may likewise include a cellophane tape or other release material 146 placed over the sealant 144 so as to again prevent the sealant from binding to any other material or object during shipment and storage. In similar fashion, the lower base member 144 likewise includes a sealant and/or adhesive 148 distributed over at least a portion of its lower surface for attaching to the damaged shingle and it may likewise include a cellophane tape or other release material 150 placed over the sealant 148. The upper surface of lower base member 144 likewise includes a sealant and/or an adhesive 152 distributed across at least a portion of its upper surface for mating with and attaching to the undersurface of the upper base member 112 and a cellophane tape or other release material 154 may likewise cover adhesive or sealant 152. The upper base member 112 is substantially identical to the upper base member associated with the two-piece shingle patch 90 illustrated in FIG. 10.

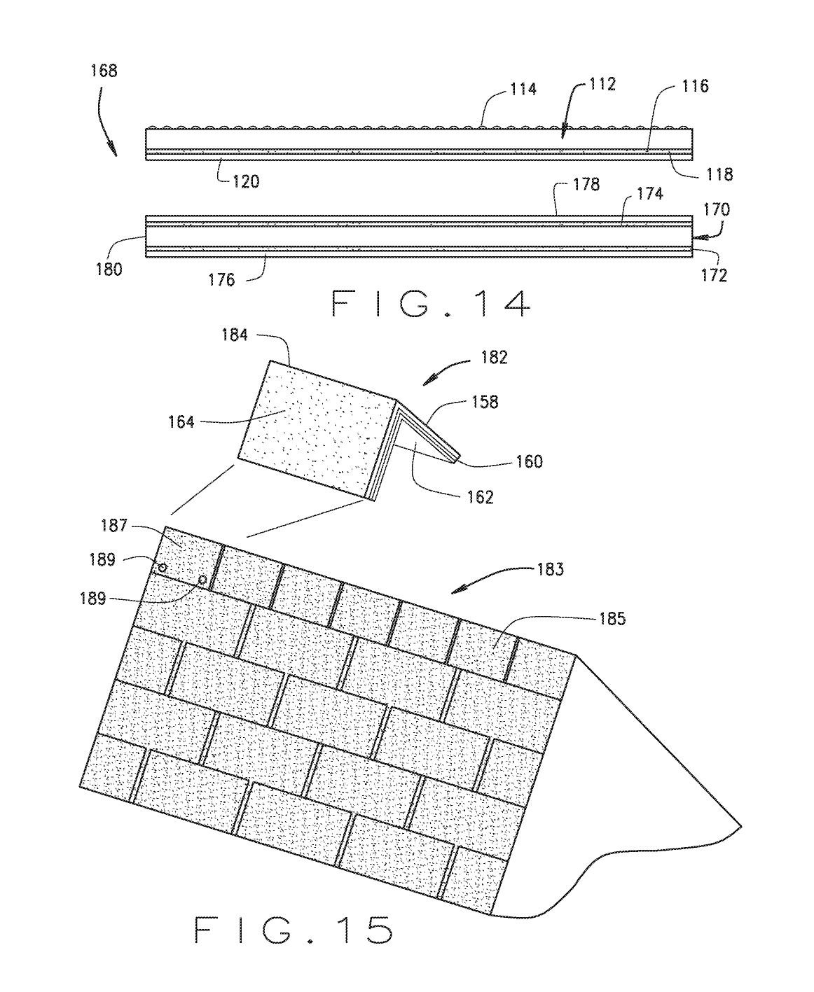

FIGS. 13 and 14 illustrate still other embodiments of the present one-piece and two-piece shingle patch. More particularly, FIG. 13 illustrates a one-piece shingle patch 156 which is substantially similar to shingle patch 70 except that notch portion 74 has been eliminated. In this particular embodiment, the patch 156 includes a base member 158 having a sealant and/or adhesive 160 distributed across at least a portion of its lower surface for mating with and attaching to the damaged shingle and further includes a cellophane tape or other release material 162 covering the adhesive 160 for reasons as previously explained. Similar to shingle patch 70, the top surface of base member 158 likewise includes colored granules 164 that are either embedded or otherwise attached to the patch material so as to match the color of the existing damaged shingle to be repaired. In this particular embodiment, the shingle patch 156 is placed over the damaged shingle and its one end portion 166 is placed in abutting relationship to the edge portion of the existing shingle located immediately above the damaged shingle. In this embodiment, the adhesive 160 provides sufficient adhesive force to bond the shingle patch 156 to the damaged shingle and the existing shingle located immediately above the damaged shingle does not have to be lifted or otherwise separated from the roofing structure to complete the repair. Shingle patch 156 is applied directly over the damaged shingle, or over exposed nails, and can be trimmed to fit the particular damaged shingle either at the factory, or by the installer in the field. Here again, the adhesive 160 provides sufficient adhesive force to bond the shingle patch 156 to the damaged shingle.

FIG. 14 illustrates a modified version 168 of the two-piece shingle patch 90 wherein again, the notched portion 94 has been eliminated from the lower base member 170. In all other respects, lower base member 170 is substantially identical to lower base member 92 and likewise includes a sealant and/or adhesive 172 and 174 covering at least a portion of its bottom and upper surfaces respectively, as well as a cellophane tape or other release material 176 and 178 which are likewise placed over the respective sealants 172 and 174 so as to prevent the sealant from binding to any other material or object during shipment and storage. The upper base member 112 is identical to base member 112 discussed above with respect to shingle patch 90. In this particular application, one end portion 180 of the lower base member 170 is again positioned in abutting relationship to the edge portion of the existing shingle located immediately above the damaged shingle and base member 170 is positioned directly over the damaged shingle, or over a shingle with exposed nails. The lower base member 170 is again sized and shaped to mate with and attach to the top surface of the damaged shingle as described above. The upper base member 112 is adhered to the lower base member 170 in a similar manner as described above with respect to shingle patch 90. Here again, shingle patch 168 does not require lifting of the existing shingle located immediate above the damaged shingle and thereby helps to preserve the attachment of the existing shingle to the roof structure.

Failures commonly seen in asphalt shingle roofs are the failures that occur when roofing nails are exposed. These exposed nails are presently unavoidable when installing every asphalt shingle roof. Asphalt shingles are installed successively, as explained above with respect to FIGS. 3-5, starting at the bottom of each roof slope with each shingle being overlapped by the next shingle placed above it. When a shingle is nailed properly, it will have a minimum of four nails used to secure it to the roof. When installed properly, these nails will be covered when the next shingle is placed over them. However, when the inevitable “last row” of shingles are installed, there will not be a successive shingle to cover those exposed nails making exposed nails unavoidable when installing new shingle roofs. Shingle manufacturers and building codes require that these exposed nails be covered with caulking as explained above. This is a weak solution because caulking only lasts a few years. The following shingle patch embodiments are new designs that eliminate caulking as the only remedy for the exposed nails. These shingle patch products will be made with the same materials as the shingles themselves; they will be fabricated using the same colors as existing shingles; and they will last for the full life of the roof. The present goal is to eliminate the ugly, non-dependable caulking that is currently used to temporarily seal exposed nails and to use the following shingle patches when new asphalt shingle roofs are installed.

FIG. 15 illustrates still another embodiment of the present one-piece shingle patch which is specifically designed to cover the exposed nails associated with the very last ridge cap shingle positioned across the peak of a particular roof such as a typical gable roof 183. The last ridge cap on the ridge line is one area where there will always be exposed nails. The ridge caps are installed last by bending them into a V-shape and nailing them down in a straight line along the apex or crown of the roof. The last cap is made by cutting one of the full size caps along the line where the granules change color. The cut piece with the right color is installed with four exposed roofing nails, one on each of the four corners. Only two of the exposed nails are illustrated in FIG. 15 since the other two exposed nails would lie on the other side of the peak. These four nails would typically be caulked as per manufacturer instructions and code requirements to temporarily prevent water intrusion and water damage.

Instead of caulking, FIG. 15 illustrates a one-piece shingle patch 182 which is substantially similar to shingle patch 156 illustrated in FIG. 13 except that shingle patch 182 is folded at an intermediate location along its length such as at fold line 184 so as to be positioned over and mate with the peak or apex of a particular roof 183 as will be hereinafter further explained. In all other respects, shingle patch 182 is again substantially similar to shingle patch 156 and includes a base member 158 having a sealant and/or adhesive 160 distributed across at least a portion of its lower surface for mating with and attaching to other ridge cap shingles or the apex of a particular roof structure as previously explained. The adhesive 160 is typically bonded to the bottom surface of the base member 158 and can cover all or just a portion of the bottom surface 158. the adhesive 160 can be made using, for example, butyl rubber, modified bitumen or any other workable substance that is compatible with asphalt shingles. This adhesive may vary in thickness, for example, between 30-80 mils. The adhesive 160 will again be covered by a thin, strong film or release tape 162 made from cellophane, silicone or any other usable substance for the reasons previously explained. Likewise, similar to shingle patch 156, shingle patch 182 likewise includes colored granules 164 associated with the top surface of base member 158 that are either embedded or otherwise attached to the patch material so as to match the color of the existing ridge cap shingles. In this particular embodiment illustrated in FIG. 15, the ridge caps 185 have been nailed to the ridge and ridge cap 187 represents the last ridge cap installed with exposed nails 189. The shingle patch 182 is placed over the apex or peak of the roof and over the last ridge cap 187 so as to cover the exposed nails 189 as illustrated in FIG. 15.

There can be any number of ridge lines associated with a particular roof depending upon the size and style of that particular roof. Instead of caulking the exposed nails as previously explained, shingle patch 182 can be used to cover those exposed nails. In this regard, shingle patch 182 is applied directly over the apex or peak of the roof where the exposed nails exist and the patch 182 can be trimmed to fit the particular area of the roof either at the factory, or by the installer in the field. Here again, the adhesive 160 provides sufficient adhesive force to bind the shingle patch 182 to the apex of the roof as illustrated in FIG. 15 by simply applying pressure to the patch or using an appropriate roller. When installed in cold temperatures, there may be a need to use an external heat source to activate the adhesive bond.

In addition, every asphalt roof shingle system starts with a first row of shingles along the bottom edge of the roof line. This first row of shingles is formed using what is called a plurality of “starter shingles”. Each starter shingle is usually a one ply asphalt shingle that is not as tall as the rest of the other shingles that will be installed on the particular roof. The starter shingles are laid in a straight line along the bottom edge of the roof and are fastened to the roof using between four or six roofing nails. The next row of shingles is a full shingle that when placed correctly will cover the starter shingle completely. All of the shingles on a typical shingled roof have a self-sealing adhesive that is applied at the factory which is designed to seal all of the shingles to each other when exposed to sunlight. The self-sealing adhesive is designed to help prevent the shingles from lifting or blowing off during high wind conditions. The top surface of the typical starter shingle also has a factory applied, self-sealing adhesive strip which bonds with the shingle that is placed over it. However, since there is no shingle below the strip of starter shingles, there is also no self-sealing adhesive available to seal the strip of starter shingles to the roof. Since the very first row of the roof is not glued down, it becomes the area most vulnerable to lifting damage during high wind conditions.

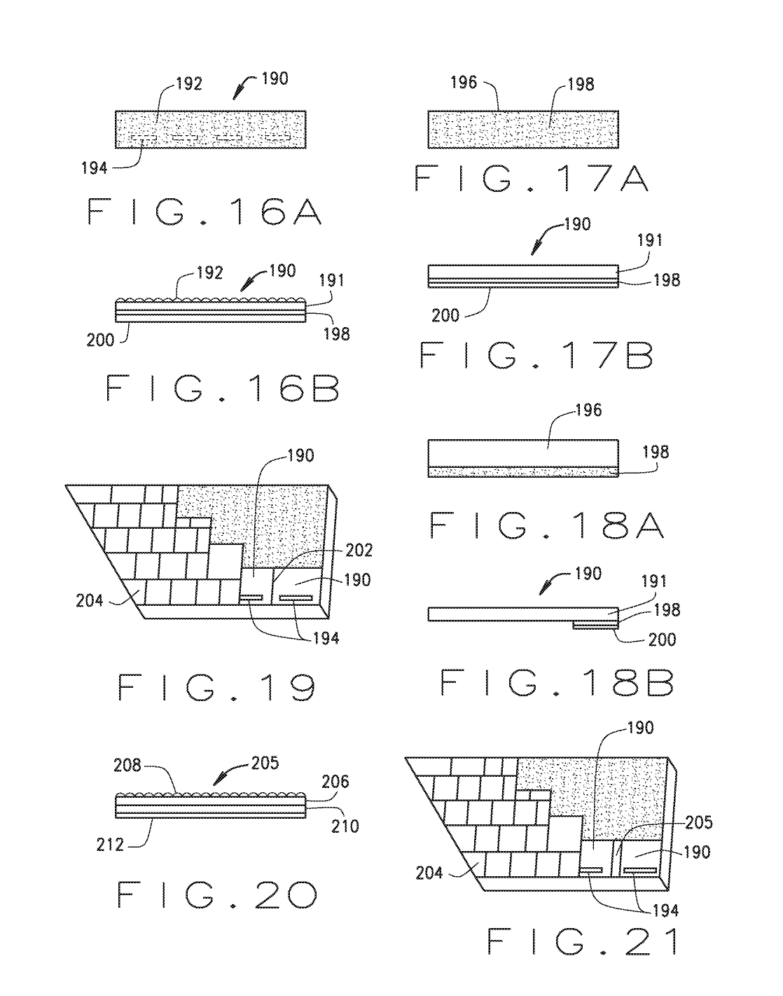

FIGS. 16-18 illustrate several embodiments of an improved starter shingle 190 having colored granules 192 imbedded into the top surface of the starter shingle or base member 191 as well as a plurality of factory installed self-sealing, sun activated adhesive strips 194 as best illustrated in FIGS. 16A, 16B, 19 and 21. The adhesive strips 194 are used conventionally to seal the shingles placed on top of the starter shingle 190. Contrary to the conventional starter shingle, the bottom surface 196 of the present improved starter shingle 190 may be completely covered with an adhesive sheet or film 198 as previously explained made from modified bitumen, or butyl rubber, or some other compatible material which is bonded to the bottom surface 196 of the starter shingle as best illustrated in FIGS. 17A and 17B. By providing an adhesive layer on the bottom surface 196 of the starter shingle 190, the starter shingle can likewise be adhesively attached to the roof structure, a feature not present in the known starter shingles. Similarly, a thin, strong film or release tape 200 (FIG. 17B) can cover the adhesive material 196 until ready for use.

In an alternative embodiment as illustrated in FIGS. 18A and 18B, the adhesive material 198 can extend over just a portion of the bottom surface 196 of the improved starter shingle 190 as illustrated in FIG. 18A and this strip of adhesive can be placed along the bottom edge of the starter shingle as illustrated. When installed, the release film 200 (FIG. 18B) will be removed from the improved starter shingle 190 and the shingle 190 will be placed in the right position on the bottom edge of the roof preferably over a well nailed metal drip edge and the starter shingle 190 will be pressed into place by hand and then completed using pressure from a suitable roller tool.

In addition, all of the improved self-sealing starter shingles 190 should have a separate, self-sealing patch adhered over each of the side seam locations where the starter shingles join together because these seams are very susceptible to leaks. Because of the often dissimilar lengths associated with the starter shingles and the shingles used for the new roof which lay over the top of the starter shingles, the installers placing the starter shingles incorrectly during installation will result in “seams on seams”. These “seams on seams” are created when the first row of shingles that are placed over the starter shingles have occasions when the seams of the overlaying shingles meet on their sides directly over the seams of the starter shingles beneath them. These “seams on seams” occurrences are “leak points” on the very first row of shingles where the greatest concentration of rain water occurs. The most common area of leaks, by far, on almost all roofs is the lower edges or perimeters, also known as the eaves, which is where the starter shingles are located. FIG. 19 illustrates a typical shingle installation wherein the bottom row of shingles includes two starter shingles 190 which are cut to size and glued to the roof structure alongside each other forming a seam 202 therebetween. Shingles 204 represent the first row of full shingles covering a portion of the starter shingles 190.

The present universal starter shingle seam cover member 205 is illustrated in FIG. 20 and again is essentially a one-piece shingle patch which is substantially similar to the shingle patch 156 illustrated in FIG. 13 except that the starter shingle seam cover member 205 is sized and shaped specifically to overlay the seam 202 illustrated in FIG. 19. In all other respects, the starter shingle seam cover member 205 includes a base member 206 which can be made from asphalt or a modified bitumen type shingle base with factory applied colored granules 208 on its top surface and a sealant and/or adhesive 210 distributed across at least a portion of its lower surface for mating with and attaching to the two side-by-side starter shingles 190 as best illustrated in FIG. 21. Here again, the adhesive 210 can be an adhesive sheet or film of modified bitumen, butyl rubber or some other comparable material as previously explained. A release tape 212 is again placed over the adhesive 210 and is removed when the seam cover member 205 is ready for use. The starter shingle seam cover member 205 can be fabricated into any assortment of shapes and sizes and can be installed over any types of starter shingles used. The starter shingle seam cover member 205 can be made, for example, with a typical asphalt shingle base material made of fiberglass asphalt, modified bitumen or other suitable materials with colored granules 208 attached to its upper surface. The seam cover member 205 can be installed over the side seams associated with adjacent abutting starter shingles using pressure as previously explained to achieve a water tight seal.

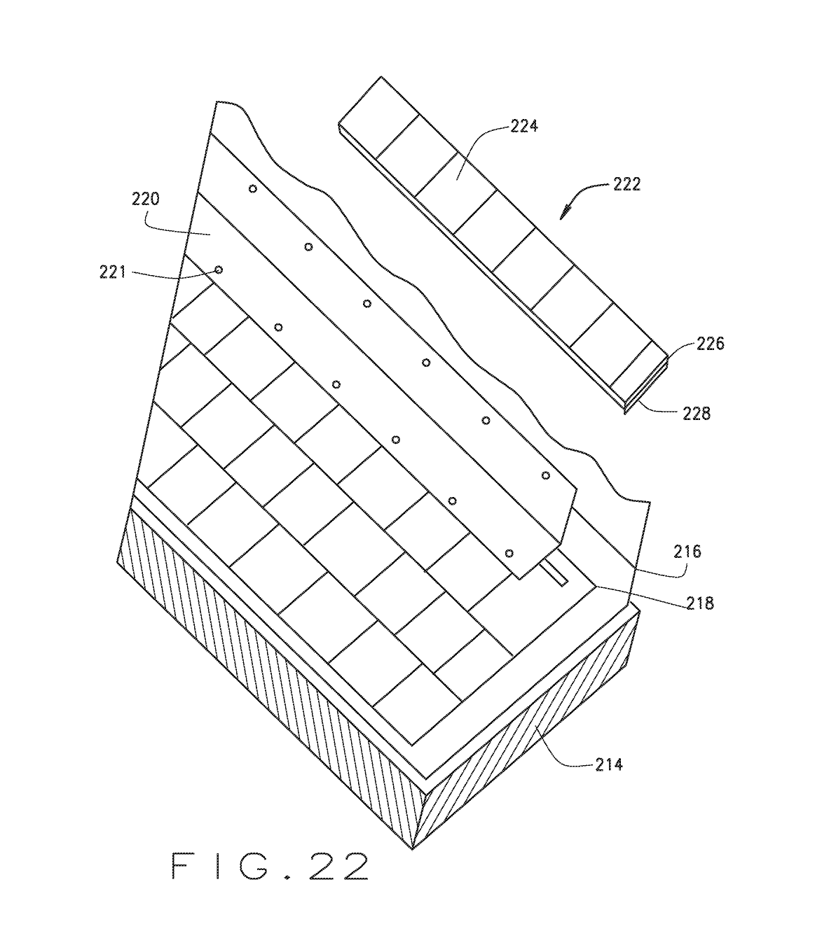

Exposed nails can likewise occur when roofing shingles are installed on slopes that terminate up against a wall or projection such as chimneys, AC units, solar panels and so forth. These areas are called headwall areas, one of which is illustrated in FIG. 22 where the roof structure 214 terminates at wall 216. This typical roof/wall intersection is made waterproof by installing shingles right up to the roof/wall intersection 218 and then, before the wall has siding or some other finish material attached thereto, a metal flashing called a headwall or L-flashing such as flashing member 220 is installed over the shingles and against the wall 216 as illustrated in FIG. 22. The flashing 220 is nailed to the roof structure and can either be covered with another row of shingles or the flashing can be left exposed. When another row of shingles is installed to hide the flashing 220, that last shingle will have all of its nails exposed making it necessary to again cover them with caulk. This design lends itself to possible leaks when blowing winds push heavy rains against the wall. The torrential rain flows down the wall 216 in sheets and will flow under the last row of shingles thereby allowing the possibility for leakage down through the holes created by all of the nails used to install the metal flashing 220 and the last row of shingles to the roof structure.

FIG. 22 illustrates still another embodiment of a shingle patch 222 for covering the exposed nails 221 associated with the flashing 220. This headwall shingle patch 222 again being substantially similar to shingle patch 156 illustrated in FIG. 13 except that the headwall shingle patch is sized and dimensioned specifically for headwall areas and installation over L-flashing 220 and the exposed nails associated therewith. Here again the shingle patch 222 can be cut into any length and includes a base portion 224 having colored granules associated therewith as previously explained, a sealant and/or adhesive 226 distributed across at least a portion of the lower surface of base member 224 for mating with and attaching to other existing shingles covering the flashing 220 or attaching directly to the flashing 220. A cellophane tape or other release material 228 covers the adhesive 226 for reasons as previously explained. During installation, the release tape 228 will be removed and the self-sealing headwall shingle patch 222 will be permanently bonded to the roof structure or flashing 220 using a suitable roller or pressure. The self-sealing headwall shingle patch 222 will create a water tight seal with no need for unsightly, non-reliable caulking.

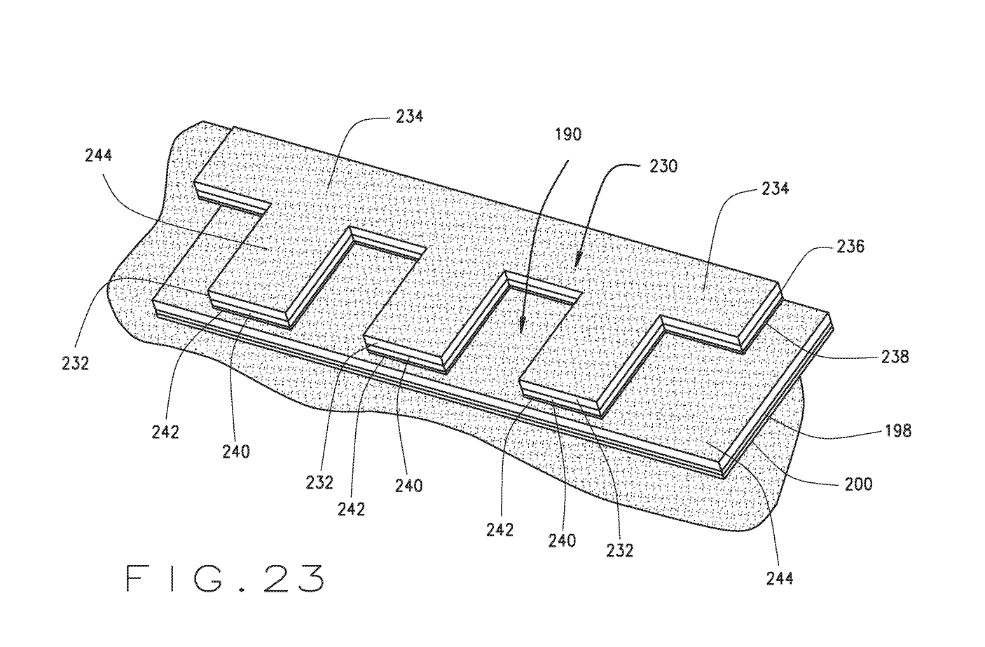

In some instances, when installing shingles with a staggered butt design such as the one-piece shingle patch 230 illustrated in FIG. 23, the self-sealing headwall shingle patch 230 will require two parts, namely, a color matching, self-sealing starter shingle 190 that is permanently bonded to the bottom of the staggered butt shingle patch 230 as illustrated in FIG. 23 as will be hereinafter further explained. The one-piece headwall staggered butt shingle patch 230 includes a plurality of spaced apart butt tabs 232 which extend from an elongated shingle portion 234 which was a full length shingle trimmed down to form the patch 230. Shingle portion 234 extends the full length of shingle patch 230 and likewise includes a sealant and/or adhesive 236 distributed across at least a portion of its lower surface for mating with and attaching to the improved starter shingle 190. A cellophane tape or other release material 238 covers the adhesive 236 for reasons as previously explained. In addition, each butt tab 232 likewise includes a sealant and/or adhesive 240 distributed across at least a portion of its lower surface for mating with and attaching to the starter shingle 190 and adhesive 240 likewise includes a cellophane tape or other release material 242 covering the adhesive 240. Both the top surface of shingle patch 230 as well as the top surface of the starter shingle 190 include colored granules 244 which are colored to match the shingles being used on the roof structure.

As previously explained, the starter shingle 190 likewise includes a sealant and/or adhesive 198 which is again covered by a release tape 200. In this particular embodiment, the shingle patch 230 in combination with the starter shingle 190 can be installed over the last shingle row or over the flashing 220 as previously explained. Here again, the adhesives 236 and 198 provide sufficient force to bond the shingle patch 230 and starter shingle 190 to the flashing 220. Once the release tape 200 from the starter shingle 190 is removed, the entire patch is sealed either to the roof structure, or to other existing shingles, or to the L-flashing 220 as previously explained.

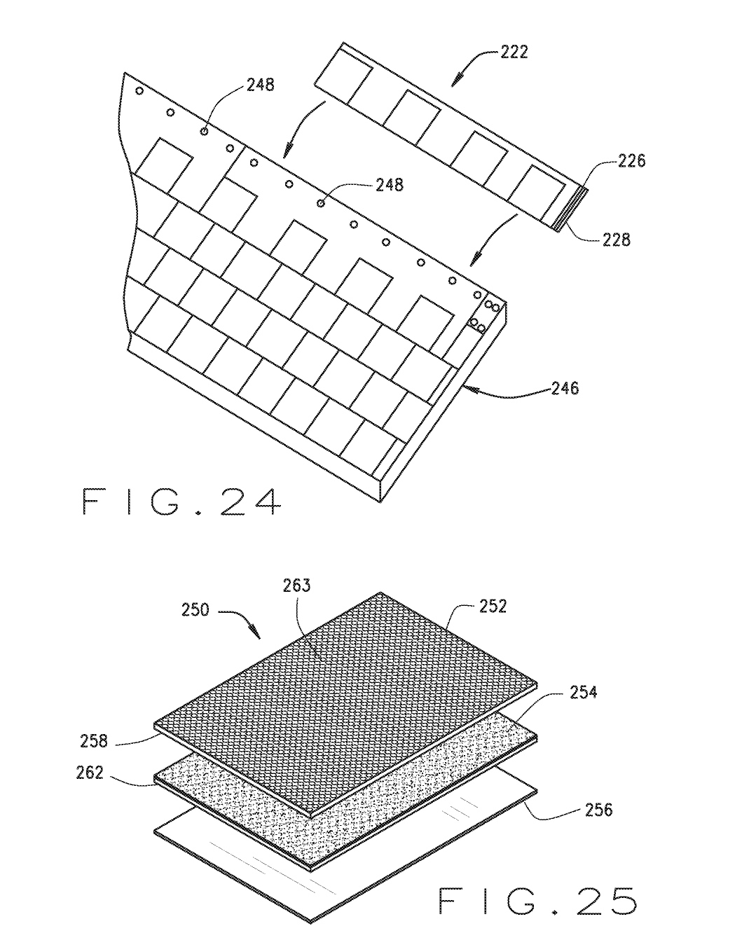

Another roof design that creates the need for last rows of shingles with exposed roofing nails are called “shed roofs”. A “shed roof” is a roof design that has an upper edge on its slope that does not meet with another slope as with a gable roof design nor does it terminate at a wall structure. A typical “shed roof” design is illustrated in FIG. 24. In this particular design, the last row of shingles must be face nailed as illustrated in FIG. 24, leaving many exposed nails that must be caulked. The solution here is to use the same self-sealing headwall shingle patch 222 previously described to cover the exposed nails 248 associated with the shed roof structure 246. Depending upon the length of the last row of shingles associated with a shed roof structure, one or more of the headwall shingle patches 222 may be necessary to cover the entire row of last shingles.

Exposed nails also appear on roofs where nails are improperly installed. In this regard, “shiners” are the name given to nails that are improperly installed under the prescribed nailing zone associated with a particular shingle thereby resulting in the fact that they will not be covered by the shingle placed above it. Sometimes the head of the shiner nail is completely visible and sometimes the head of the shiner nail is only partially covered by the next shingle, leaving only a half of the nail head or less exposed. Since exposed shiner nails can cause roof leaks, the building codes require that all shiners likewise be caulked.

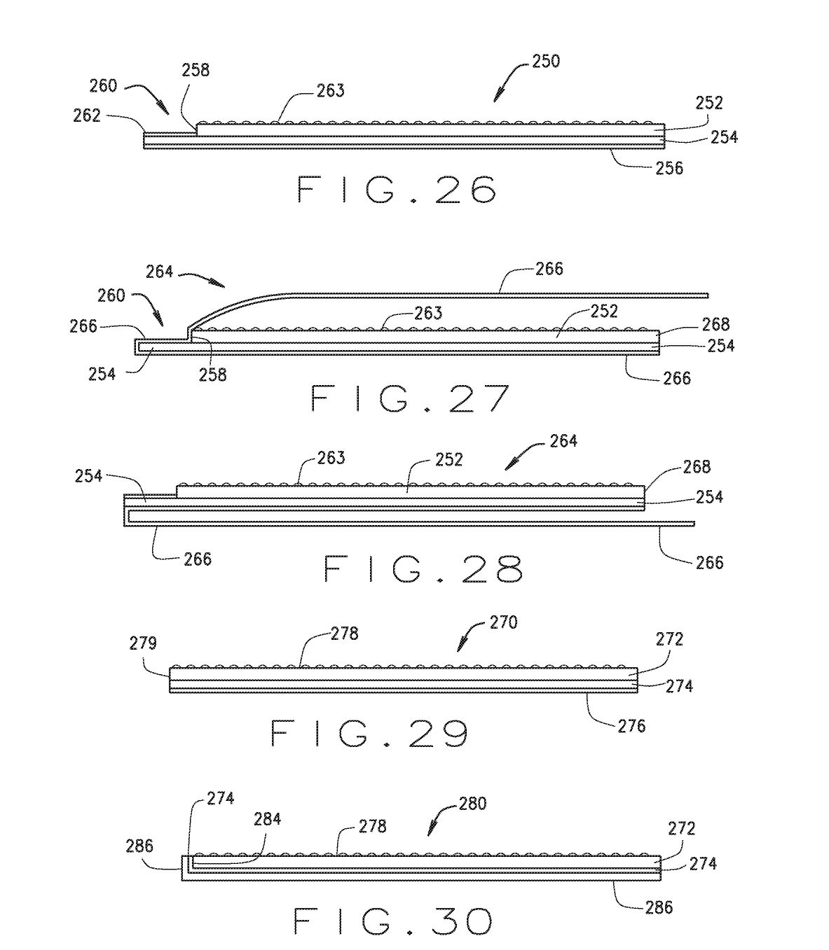

FIGS. 25 and 26 illustrate a shiner patch 250 which can be manufactured of the same material types as the shingles used on a particular roof. However, the shiner patch 250 will be produced in smaller versions of the shingles so that they can be used as a patch to cover accidentally exposed nail heads. These shiner patches can be available in different widths, lengths and colors to match the colors of the roof that have the shiner nails present and exposed. As a result, shiner patch 250 includes a base member 252 made of the same material as the attached shingles and an adhesive layer 254 is likewise bonded to the bottom surface of the base member 250. This adhesive layer 254 is a thin sheet formed from a two-sided adhesive tape made using, for example, butyl, modified bitumen, or any other workable substance that is compatible with asphalt shingles. Importantly, the adhesive layer 254 may vary in thickness and will likewise be covered by a protective release tape 256. Importantly, the adhesive layer 254 and the release tape 256 will extend past the top edge portion 258 of the base member 252 anywhere from one quarter to one half or more of one inch so as to create a notched portion 260. Again, the notch portion 260 is formed from the use of the double sided adhesive tape and will likewise include another adhesive layer 262 covering the exposed notch portion 260 as best illustrated in FIG. 26. This shiner patch can be used on new roofs where the shingle located above the shiner nail can be easily lifted so that the notch portion 260 can be positioned under the shingle located immediately above. When installing the shiner patch 250, a user will release the release tape 262 from the top of the notch portion 260 as well as removing the release tape 256 from the bottom portion of the patch 250 and will then slide the patch under the lifted lower edge of the shingle located immediately above the shiner nail. The user will then press the shiner patch 250 into place by hand over the shiner nail and then complete the attachment process by using pressure or a suitable roller tool. It is also recognized and anticipated that the release tape 256 associated with the bottom portion of the shiner patch 250 could likewise be folder over to cover the top portion of the notch portion 260 so that one single release tape is utilized.

In an alternative embodiment, a one-piece shiner patch 264 as best illustrated in FIGS. 27 and 28 can likewise be utilized. Shiner patch 264 is substantially similar to shiner patch 250 and includes the same base member 252 and the same adhesive layer 254 as discussed above with respect to shiner patch 250. Here again, the notch portion 260 is formed simply by extending the double sided adhesive tape 254 beyond the top edge portion 258 of base member 252. Shiner patch 264 differs from shiner patch 250 in the use of release tape 266 which is a removable extra-long release film member which extends completely across the bottom portion of the shiner patch 264 and extends up and over the top portion of notch portion 260 and up and over the top surface of shiner patch 264 as illustrated in FIG. 27. Ideally, release tape 266 will extend across the top portion of shiner patch 264 and past the opposite side edge portion 268 of base member 252 as illustrated in FIG. 27. Obviously, the release tape 266 need not be attached to the top surface of base member 252.

When installing shiner patch 264, a user will release the film from the top of the notch portion 260 and will fold the release tape 266 back under the bottom surface of the patch so that the release tape will stick out from the underside portion of the patch past the top edge portion 268 of body member 252 as illustrated in FIG. 28. The user will then slide the notched portion 260 of the patch 264 under the lifted lower edge of the shingle located immediately above the shiner nail and would then pull the rest of the release tape 266 out from under the patch 264 and press it into place by hand and then complete the attachment process using pressure or a suitable roller tool as explained above. By providing an extra-long release tape 266 so that it can be folded under the bottom portion of the patch 264 and past the top edge portion 268 provides a means for the user to easily grab hold of the release film after the notch portion has been inserted under the lower edge of the shingle located immediately above the shiner nail. It is recognized and anticipated that the release tape 266 need not extend all the way to the opposite top edge portion 268 of patch 264 so long as the release tape 266 can be folded back under the patch so that at least a portion of the release tape is exposed for easy grasping by a user to complete the attachment process.

It is also recognized and anticipated that each of the shiner patches 250 and 264 will likewise include colored granules 263 associated with the top portion of the base member 252 that are either embedded or otherwise attached to the patch material forming the base member so as to match the color of the existing shingles on a particular roof structure.

FIG. 29 illustrates still another embodiment of a shiner patch 270 which can be used on older roofs where the shingle positioned immediately above the shiner nail cannot be easily lifted so as to insert a notch portion thereunder. In this event, shiner patch 270 is substantially similar to shiner patch 250 except it does not include notch portion 260. Instead, shiner patch 270 includes a base member 272 substantially similar to base member 252, an adhesive layer 274 substantially similar to adhesive layer 254 and release tape 276 substantially similar to release tape 256. The top surface of shiner patch 270 will likewise include colored granules 278 as previously explained. When installing shiner patch 270, release tape 276 is removed from the bottom surface of the patch 270 and the patch 270 is positioned over the shiner nail such that one side edge portion of patch 270, such as side edge portion 279, is butted against the lower edge portion of the shingle located immediately above the shiner nail. Once in this position, the user will press the patch into place by hand and then complete the attachment process using pressure or a suitable roller tool. In an alternative embodiment 280 illustrated in FIG. 30, the base member 272 may further include an adhesive layer 274 associated with one side edge portion of the base member 272 such as side edge portion 284 and adhesive layer 274 may be the same adhesive throughout or a different adhesive may be used along side edge portion 284. Also, adhesive layer 274 may be covered by a single release tape 286 which extends over the bottom portion of base member 272 and extends up and over side edge portion 284 as illustrated in FIG. 30. This allows a user to butt side edge portion 284 with adhesive 274 associated therewith up against the lower edge portion of the shingle located immediately above the shiner nail so as to form a seal along that edge portion. This seal will help to further prevent water and moisture from penetrating into the seam formed between shiner patch 280 and the adjacent shingle thereby further protecting the integrity of the seal and the attachment of the shiner patch 280 over an existing shiner nail.

It is also recognized and anticipated that many of the above-referenced shingle patches such as shingle patches 250, 264, 270 and 280 can also be used to cover damaged shingles where damage has been caused due to a wide variety of different weather-related events including hail damage, storm damage, wind damage and the like. So long as the entire shingle does not have to be replaced, any one of the above-referenced shingle patches can be sized and dimensioned to overlay the damaged area of the asphalt shingle thereby avoiding the need to remove and replace the damaged shingle and surrounding shingles and presenting a faster system for repairing such damage without necessarily removing the damaged shingle.

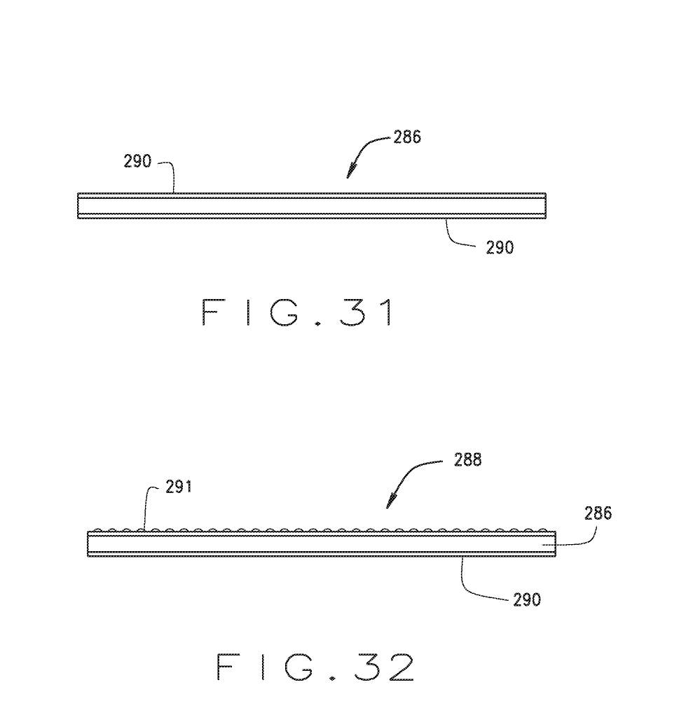

Still further, it is also recognized and anticipated that a shingle patch can be formed using solely a double sided adhesive tape 286 having a removable release film 290 associated with each opposite side thereof as illustrated in FIG. 31. In this particular embodiment, shingle patch 288 (FIG. 32) is formed solely from the double sided adhesive tape 286 by removing the release film 290 associated with its top surface portion and thereafter embedding or otherwise attaching color granules 291 to the top surface of the double sided tape 286 so as to match the color of the existing shingle which includes either a shiner nail or a damaged portion. Shiner patch 288 is best fabricated in the field where release tape 290 can be removed from the double sided tape 286 and the bottom surface of patch 288 can be placed over the shiner nail or over the damaged shingle area. Once the patch has been properly positioned, the release tape associated with the top surface of double sided tape 286 can be removed and a user can sprinkle colored granules over the adhesive associated with the top surface thereby matching the patch 288 to the existing shingles. This forms a quick and inexpensive shingle patch which will blend in and match the existing shingles.

All of the shingle patches disclosed herein including shingle patches 70′, 182, 190, 205, 222, 230, 250, 264, 270 and 280 can be made by modifying existing stock shingles of different styles, colors and manufacturers by cutting them to size so as to fit the particular application. The shingle patches can be made in various sizes and repackaged and sold through the distributor chains that sell the matching shingles, thus making these shingle patches readily available for use. All of the above-disclosed shingle patches are installed without the use of nails as the adhesives alone provide the permanent and waterproof bonding together of all surfaces. It is also recognized and anticipated that the adhesives used in the above-referenced shingle patch embodiments can take on a wide variety of different forms depending upon the application including the use of a double side adhesive tape with a removable release film associated therewith. For example, the following adhesives could be used on any one of the above referenced shingle patches depending upon the particular application:
1) A modified bitumen adhesive can be used similar to the type that is used by shingle manufactures to bond the various components of laminated shingles and the same type of adhesive that is also used by shingle manufacturers to provide the sealing adhesive that is activated by the sun after the shingles are installed. This adhesive is highly aggressive, long lasting and glues the separate shingles together when the hot sun softens the material to the point that it will become like a hot glue. This type of adhesive can be applied to the underside of the above referenced patches and to the notched areas of the notched type patches in sufficient quantities so as to accomplish a compatible bonding medium between the asphalt shingle patch and the existing shingle over which it is laid. This type of adhesive will require a heat source when installed to assure immediate adhesion and so as not to rely solely on the heat of the sun to affect a secure bonding. This can be accomplished by using a typical electric, hot air blowing roofing membrane welder tool;
2) The same type of adhesive described above can also be supplied using a hot glue gun tool where the installer will apply the adhesive in the field during the installation process. The hot adhesive can either be installed over the existing shingle, to the back of the shingle patch, or any combination of the two;
3) Adhesives which are not heat activated can likewise be used and these types of adhesives are typically available for purchase everywhere in tubes that can be brought to the job site and can be administered by using a standard caulking gun tool. Here the installer will administer the correct quantity of sealant in the correct locations as described above;
4) Two part asphalt/epoxy or the like adhesives can likewise be utilized in the field. These types of adhesives have an aggressive bonding characteristic as well as a fast curing characteristic.

Understanding the scope of the present invention, the term “comprising” and its derivatives, as used herein, are intended to be open-ended terms that specify the presence of the stated features, elements, components and/or groups, but do not exclude the presence of other unstated features, elements, components and/or groups. The foregoing also applies to words having similar meanings such as the terms “including”, “having” and their derivatives. The terms of degree such as “substantially”, “about” and “approximate” as used herein mean a reasonable amount of deviation of the modified term such that the end result is not significantly changed.

Only selected embodiments have been chosen to illustrate the present inventions. The various constructions described above and illustrated in the drawings are presented by way of example only and are not intended to limit the concepts and principals of the present inventions. It is also recognized and anticipated that the size, shape, location and other orientation of the various components and/or elements associated with the present inventions can be changed as needed and/or as desired depending upon a particular application. Components that are shown directly connected or contacting each other can have intermediate structures disposed between them. In addition, the functions of one element can be performed by two elements, and vice versa. The structures and functions of one embodiment can also be adopted in another embodiment. It is not necessary for all advantages to be present in a particular embodiment at the same time. Thus, the foregoing descriptions of the embodiments according to the present inventions are provided for illustration only, and not for the purpose of limiting the inventions as defined by the appended claims and their equivalents.

Thus, there has been shown and described several embodiments of a novel shingle patch for damage repair of asphalt shingles. As is evident from the foregoing description, certain aspects of the present inventions are not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. All such changes, modifications, variations and other uses in applications which do not depart from the spirit and scope of the present inventions are deemed to be covered by the inventions which are limited only by the claims which follow.

1. A non-metal asphalt shingle patch used for repairing a damaged portion of a damaged asphalt shingle or for overlaying exposed nails on a roof, the shingle patch comprising:
a base member having top and bottom surfaces and opposed end portions, the base member being sized and shaped to overlay the damaged portion of the damaged asphalt shingle or the exposed nails on a roof;
a notched portion formed within said base member located at one end portion of said base member, said notched portion being tapered and being sized and shaped to be inserted under an existing shingle such that at least a portion of the existing shingle will rest on top of the notched portion; and
a sealant covering said notched portion for attaching the notched portion to the existing shingle and a sealant covering at least a portion of the bottom surface of said base member for attaching the base member to the damaged portion of the damaged asphalt shingle or to another existing shingle.

2. The shingle patch defined in claim 1 including release tape overlaying the sealant covering the notched portion and the bottom surface of the base member.

3. The shingle patch defined in claim 1 wherein the base member and the notched portion include a thickness, the thickness of the notched portion being thinner than the thickness of the base member.

4. The shingle patch defined in claim 1 including a ledge located between the notched portion and the remainder of the base member.

5. The shingle patch defined in claim 1 wherein the sealant is a heat activated sealant.

6. The shingle patch defined in claim 1 including color granules associated with at least a portion of the top surface of the base member.

7. A non-metal asphalt shingle patch for overlaying exposed nails associated with a last ridge cap shingle adjacent a peak on a roof, the shingle patch comprising:
a base member having top and bottom surfaces and opposed end portions, the base member being sized and shaped to overlay the exposed nails associated with the last ridge cap shingle, the base member being folded at an intermediate location along its length so as to mate with the peak of the roof; and
a sealant covering at least a portion of the bottom surface of said base member for attaching the base member to the last ridge cap shingle.

8. The shingle patch defined in claim 7 including release tape overlaying said sealant covering at least a portion of the bottom surface of said base member.

9. The shingle patch defined in claim 7 including colored granules associated with at least a portion of the top surface of said base member.

10. A non-metal asphalt shingle patch used for repairing a damaged portion of a damaged asphalt shingle or for overlaying exposed nails on the roof, the shingle patch comprising:
a base member having top and bottom surfaces and opposed end portions, the base member being sized and shaped to overlay the damaged portion of the damaged asphalt shingle or the exposed nails on a roof;
a sealant member covering at least a portion of the bottom surface of said base member for attaching the base member to the damaged portion of the damaged asphalt shingle or to another existing shingle, the sealant member extending past one end portion of the base member to form a notched portion adjacent the one end portion of the base member, said notched portion being sized and shaped to be inserted under an existing shingle such that at least a portion of the existing shingle will rest on top of the notched portion.

11. The shingle patch defined in claim 10 including release tape overlaying the sealant member forming the notched portion and the sealant member covering at least a portion of the bottom surface of the base member.

12. The shingle patch defined in claim 10 including release tape overlaying the sealant member covering at least a portion of the bottom surface of the base member and the sealant member forming the notched portion, the release tape further extending over the top surface of the base member and extending past the end portion of the base member opposite the notched portion.

13. A shingle patch for overlaying exposed nails on a roof, the shingle patch comprising:
a two sided adhesive tape having top and bottom adhesive surfaces and opposed end portions, the two sided adhesive tape being sized and shaped to overlay the exposed nails on a roof;
the bottom adhesive surface attaching the two sided adhesive tape to another existing shingle having the exposed nails; and
color granules attached to the top adhesive surface of the two sided adhesive tape.

14. The shingle patch defined in claim 13 wherein the two sided adhesive tape is made from at least one of butyl rubber, modified bitumen, and a heat activated adhesive film.

15. A starter shingle for overlaying a roof structure, the starter shingle comprising:
a base member having top and bottom surfaces and opposed end portions;
at least a portion of the top surface of said base member including colored granules and at least a portion of the top surface of said base member including a sealant for attaching to another shingle;
at least a portion of the bottom surface of said base member including a sealant for attaching the base member to a roof structure.

16. The starter shingle defined in claim 15 including release tape overlaying the sealant covering at least a portion of the bottom surface of the base member.

17. The starter shingle defined in claim 15 wherein the sealant covering at least a portion of the bottom surface of the base member covers the entire bottom surface of the base member.

18. The starter shingle defined in claim 15 wherein the sealant is a heat activated sealant.

19. A shingle patch for overlaying exposed nails on an existing shingle on a roof comprising:
a first elongated shingle portion having top and bottom surfaces, opposed side portion and opposed end portions, said first elongated shingle portion having a plurality of spaced apart tab members extending from one of said opposed side portions, said tab members having top and bottom surfaces;
a sealant covering at least a portion of the bottom surface of the first elongated shingle portion and at least a portion of the bottom surface of each of said plurality of tab members for attaching the elongated shingle portion and the tab members to a second shingle;
said second shingle having a base member with top and bottom surfaces and opposed end portions, said second shingle being sized and shaped to underlay said first elongated shingle portion and said plurality of tab members, at least a portion of the top surface of the base member of said second shingle having color granules associated therewith and at least a portion of the bottom surface of the base member of said second shingle having a sealant associated therewith for attaching to another shingle; and a release tape overlaying the sealant covering at least a portion of the bottom surface of the base member of said second shingle.

20. A non-metal asphalt shingle patch used for overlaying an exposed nail on a roof, the shingle patch comprising:
a base member having top and bottom surfaces and opposed end portions, the base member being sized and shaped to overlay the exposed nail on a roof;
a sealant covering at least a portion of the bottom surface of said base member for attaching the base member to another existing shingle having the exposed nail;
color granules associated with at least a portion of the top surface of the base member;
a release tape overlaying the sealant covering at least a portion of the bottom surface of the base member;
one of the opposed end portions of said base member being positioned in abutting relationship with an edge portion of an existing shingle located immediately above the exposed nail when the base member is positioned in overlaying relationship with the exposed nail.

21. The shingle patch defined in claim 20 including a sealant covering the one opposed end portion of the base member which is positioned in abutting relationship with the edge portion of the existing shingle located immediately above the exposed nail.

22. The shingle patch defined in claim 20 including a release tape overlaying the sealant covering the one opposed end portion of the base member.

23. A non-metal asphalt shingle patch used for overlaying exposed nails on a roof, overlaying flashing associated with a roof/wall intersection, or overlaying exposed nails on the last row of asphalt shingles on a shed roof, the shingle patch comprising:
a base member having top and bottom surfaces and opposed end portions, the base member being sized and shaped to overlay any one of the exposed nails on a roof, the flashing associated with a roof/wall intersection, or the exposed nails on the last row of asphalt shingles on a shed roof;
a sealant covering at least a portion of the bottom surface of said base member for attaching the base member to any one of the exposed nails on a roof, the flashing associated with a roof/wall intersection, or the exposed nails on the last row of asphalt shingles on a shed roof;
a release tape overlaying the sealant covering at least a portion of the bottom surface of the base member; and
color granules associated with at least a portion of the top surface of the base member.

24. A non-metal asphalt shingle patch used for overlaying an exposed seam between two side-by-side abutting starter shingles, the shingle patch comprising:
a base member having top and bottom surfaces and opposed end portions, the base member being sized and shaped to overlay the seam formed between the two side-by-side abutting starter shingles;
a sealant covering at least a portion of the bottom surface of said base member for attaching the base member over the seam formed between the two side-by-side abutting starter shingles; and
a release tape overlaying the sealant covering at least a portion of the bottom surface of the base member.

25. The shingle patch defined in claim 24 wherein the sealant is a heat activated sealant.

26. The shingle patch defined in claim 24 including colored granules associated with at least a portion of the top surface of the base member.
